(19) United States
(12) Patent Application Publication
(10) Pub. No.: US 2009/0225682 A1
(43) Pub. Date: Sep. 10, 2009

(54) Optimization Procedure for Wireless Networks Operating in Infrastructure Mode with Standard Protocol IEEE 802.11

(76) Inventors: Alex Peter Grote-Lopez, Vina del Mar (CL); Nelson Genaro Garrido-Navarro, Tocopilla (CL); Isabel Carolina Delgado-Ruz, Santiago (CL); Walter Uwe Grote-Hahn, Vina del Mar Alto (CL)

Correspondence Address: Eric Hanscom;Law Offices of Eric Hanscom, 7395 Portage Way, Carlsbad, CA, 92011, US

(21) Appl. No.: 12/226,086

(22) PCT Filed: Jan. 16, 2007
(86) PCT No.: PCT/US07/60548

§ 371 Date: Mar. 30, 2009

(30) Foreign Application Priority Data
Apr. 4, 2006 (CL) CL 764.2006

(51) Int. Cl. H04L 12/28; H04W 4/00

(52) U.S. Cl. 370/255; 370/338

(57) ABSTRACT

The present invention is a procedure that allows configuring a random access IEEE 802.11 wireless network, operating in infrastructure mode (all terminals communicate exclusively with an AP (Access Point)), in such a way that throughput is optimized when the network is saturated, satisfying traffic characteristics, in presence or absence of the hidden terminal phenomenon and the number of terminals that communicate with the AP. It may be applied to networks that run a specific application or to those that have devices that run different applications. This procedure can be translated into a program that is operated by a wireless network administrator for network configuration. This program may also be incorporated into the configuration program of an AP and devices conforming to these standards. This invention can be applied to devices that act as AP's, such as a bridge, switch or router and the configuration can be manual or automatic, static or dynamic.

### FIELD OF THE INVENTION

The present invention relates to the field of wireless local area networks (WLANs) and more particularly to a procedure to optimize the parameters of configuration of a wireless local area network (WLAN).

### BACKGROUND OF THE INVENTION

Wireless networks are one of the areas of greatest growth in the industry of the telecommunications nowadays. In particular, thanks to the flexibility and low associated costs that WLANs offer, they have become popular as an access solution for Internet end users.

In XP000947377, from Feb. 29, 2000, titled “Performance Analysis of the IEEE 802.11 Distributed Coordination Function” of G. Bianchi, the throughput of the IEEE 802.11 standard is studied, in which an analytical model is developed to calculate the throughput when the wireless network is saturated, where the effect of hidden terminals in a network where terminals communicate with an AP is modeled superficially. The present invention considers the presence of hidden terminals, whose effect on the MAC layer of the IEEE 802.11 protocol has been analyzed more deeply than the cited document.

In the publication “A Simple Model of IEEE 802.11 Wireless LAN.”, In Proc. IEEE International Conferences on Info-Tech and Info-net (ICII), Beijing, volume 2, pages 514-519, October 2001 of H. Wu, Y. Peng, K. Long and S. Cheng the model presented in XP000947377 is modified taking into account that there are a maximum possible number of retransmissions for each information packet.

In the article “The Impact of Backoff, EIFS and Beacons on the Performance of IEEE 802.11 Wireless LANS”, In Proc. 4th IEEE Symposium on Computer and Dependability, Chicago, pages 103-112, March 2000, of R. German and A. Heindl, the performance of the IEEE 802.11 protocol is evaluated by means of simulation subject to different load conditions and varying parameters of the backoff algorithm. It does not include the hidden terminal effect and does not differentiate uplink from downlink traffic from the point of view of the AP. The present invention incorporates these factors to optimize the operation of the network when it is saturated.

The patent application WO3005025140, from Mar. 17, 2005, titled “Method and Apparatus to Adapt Threshold for Activating a Data Frame Protection Mechanism” of V. Kondratiev and B. Ginzburg presents a procedure and a device capable of activating an information packet protection mechanism that triggers itself with an adaptable threshold; the protection mode is the RTS/CTS (Request To Send/Clear To Send) reservation mechanism. The references indicated in WO3005025140 also use the RTS/CTS system to increase network throughput in presence of hidden terminals. However, the referred patent application does not mention that the threshold level for the AP and the mobile terminals may be of different values, according to how the wireless network is functioning when operating in infrastructure mode. The reason for this omission is that the background art developed up to now does not differentiate the AP from the rest of the terminals; this matter is covered in the present invention.

The patent application WO2005034437, from Apr. 14, 2005, titled “Systems and Methods for Contention Control in Wireless Networks” of L. Changwen propose a system and a method to control channel access in a WLAN. A dynamic method is suggested where a parameter of the contention window size is varied according to a threshold. However, no differentiation is made between AP and mobile terminals, providing a system that only bases itself on dynamically setting the value of the contention window for unsuccessful transmissions for a fixed threshold.

The patent application US2005064817, from Mar. 24, 2005, titled “Device, System and Method for Adaptation of Collision Avoidance Mechanism for Wireless Network” by B. Ginzburg proposes an apparatus, system and method to control channel access in a WLAN. A dynamic method is suggested based on fluctuating a parameter that determines the contention window size depending on the number of mobile terminals present or according to the probability of collisions. Suggestions of the contention window size are given in this patent based on the number of the active terminals but does not justify how these values were obtained. US2005064817 does not provide arguments that justify the values to configure the initial and final values of the contention window and only suggests that a method could exist to obtain them. Additionally it does not contemplate different types of traffic over the WLAN or the presence of hidden terminals.

The Company Cisco provides configuration tables of the contention window size based on different types of traffic at the following web address http://www.cisco.com/univercd/cc/td/doc/product/access/mar_{—}3200/mar_wbrg/o13qos.htm#wp1035143, but it does not provide means to calculate these values. The recommended values for the AP configuration do not consider the number of mobile terminals connected to the AP. Additionally, the values displayed in the tables provided by Cisco suppose that the tables are destined to devices that are Cisco Bridges and where data packages are marked in the source with different priorities according to the type of traffic which they represent, to grant quality of service (QoS). This procedure is not valid for non-Cisco devices, since they generally do not provide these configuration options.

No studies in the literature concerning the present invention have been found. The present invention introduces a differentiated network analysis operating under saturation with the IEEE 802.11 protocol in infrastructure mode, with a clear distinction between uplink and downlink traffic. It also presents a guide to configure a WLAN in infrastructure mode. For the particular case of wireless networks functioning with the IEEE 802.11 protocol in the infrastructure mode with hidden terminals, there are no developed models that allow a proper choice of the configurable parameters.

Therefore, a procedure is proposed that provides better performance for a wireless network with terminals that access it, presuming that the AP is not capable of distinguishing the nature of the transmitted packets. This means that the AP is not capable of differentiating data packets associated to voice, text or multimedia transmissions. This procedure may be systematized to be turned into a program to configure the network. This program can be incorporated to the configuration program of the AP.

### BRIEF SUMMARY OF THE INVENTION

The standard proposed in 1999 by the IEEE “Standard for Information Technology-Telecommunications and Information Exchange between Systems—Local and Metropolitan Area Networks—Specific Requirements-Part 11: Wireless LAN Medium Access Control (MAC) and Physical Layer (PHY)” for Wireless Local Area Networks is 802.11, which specifies physical and medium access layers. The IEEE 802.11 protocol is a wide variety of protocols, in which the MAC layer is almost identical for all the variants. The variants are related with the physical layer and have relation with the information transmission mechanism, which is translated in frequencies employed and different transmission capacities. The IEEE 802.11b variant operates in the non-licensed “S” band frequency of 2.5 GHz with a maximum transmission rate of 11 Mbps, employing DSSS (Direct Sequences Spread Spectrum) modulation techniques. The IEEE 802.11a variant operates in the non-licensed “M” band frequency of 5.8 GHz with a maximum transmission rate of 54 Mbps, employing OFDM (Orthogonal Frequency Division Multiplexing) modulation techniques. The IEEE 802.11g variant operates in the non-licensed “S” band frequency of 2.5 GHz with a maximum transmission rate of 54 Mbps employing OFDM modulation techniques, using the same channels and bandwidths as the IEEE 802.11b standard. There are additional variants to the standard, but from the point of view of the MAC layer protocol all the variants presented here have similar characteristics. Only when the different versions of the standard exert a relevant effect over the wireless network capacity, a distinction will be made.

The terminals in a WLAN which function according to the IEEE 802.11 standard may operate in Ad-Hoc mode or infrastructure mode. In the Ad-Hoc mode, the communication between terminals is without intermediaries. However, when they communicate using the infrastructure mode, the terminals exchange messages with each other or with a wired network using a central intermediary node called Access Point (AP). An example that illustrates the devices of a network in a wireless network operating in the infrastructure mode is detailed in FIG. 1; four terminals (140, 150, 160 and 170) may access Internet (100) through an AP (130), which in turn is connected to a router or switch (110). The AP is a device that may be defined as a router, switch or wireless bridge in the context of the configuration procedure in infrastructure mode, described in the present invention.

A wireless network that functions with the IEEE 802.11 protocol may operate with a multiple access protocol (DCF—Distributed Coordination Function) or an AP coordinated access protocol (PCF—Point Coordination Function) which regulates and manages the use of the shared channel. Most of the commercially available AP's only provide the DCF mode. This invention is aimed at optimizing wireless network performance operating in the DCF mode, therefore with more versatile AP models one must set the AP to operate in that mode first.

The IEEE 802.11 protocol working in the DCF mode coordinates the AP and terminals access to the shared wireless channel. This channel access mechanism is known as basic access and uses the CSMA/CA (Carrier Sense Multiple Access with Collision Avoidance) protocol. This protocol establishes that before transmitting, the terminal (or AP) must detect if the channel is busy. If a transmission is detected, then the terminal (or the AP) inhibits itself from transmitting. If the channel is idle, the terminal transmits, unless the channel has been reserved previously for a time required by another terminal for a message exchange, in which case the reservation period has been specified in the message header. A terminal will also inhibit itself from transmission if its backoff counter has not reached zero yet. This operation mode is known as basic access and is the most appropriate when all terminals in the network are capable of receiving the transmissions from all their peers.

The random access mechanism for the shared channel of the IEEE 802.11 standard incorporates a transmission inhibition method, which tries to diminish the probability that simultaneous transmissions occur between one or more terminals, or of the AP and one or more terminals. The simultaneous transmission is known as a collision and results, in almost all cases, that the receiver does not receive the transmitted data correctly. The inhibition method starts when a terminal (or AP), that has a data packet to transmit, randomly picks an initial value of the backoff counter. The range of values that the terminal uses to pick its initial value is [0, CWmin=2^{m}−1], where m is an integer number, whose value may be in the range [2, 10]. Then the terminal (or AP) verifies that the channel is idle during a defined time period called collision interval time slot, decreasing the backoff counter in one unit. The terminal (or AP) proceeds decreasing the backoff counter successively until it reaches zero. When this value is reached, the terminal (or AP) transmits. The initial backoff counter number is set by choosing randomly a number between [0, CWmin]. Each time a transmission is not successful, this range is increased to [0, min(2ⁱ·CWmin, CWmax)], where i is a whole number that indicates how many retransmissions have been made and min(a, b) specifies that the smaller value between a and b must be chosen. This procedure is known as binary exponential backoff algorithm.

Wireless network performance is expressed in terms of how efficiently the shared transmission medium (wireless channel) has been utilized. It is measured in terms of throughput, which is the amount of Internet layer data that has been transferred in a time unit, contemplating the management time taken to perform the transmission. An adequate initial choice of CWmin is translated into a lower probability of retransmissions of network packets, improving the global throughput of the wireless network. Normally terminals (MT—Mobile Terminals) are set to CW_{MT}=CWmin, according to the default value in the corresponding variant of the standard (in IEEE 802.11b CWmin=31, or equivalently, m=5; as for IEEE 802.11a or IEEE 802.11g, CWmin=15, or equivalently, m=4). These default values are not always possible to change in the commercially available wireless devices. Generally, diminishing this value is desirable because terminals reduce the time between transmissions, and more so when retransmitting. On the other side, the undesirable effect of using a smaller value of this parameter is that the probability of collisions increases with a saturated network.

The examples shown in this invention use CW_{MT}=31 for the IEEE 802.11b protocol employed in all terminals. This is the default value that the commercially available devices are set to (that operate with this standard), as it may be observed in FIG. 2. This figure presents the parameters used in the equations in the first column. The second column shows the default values that these parameters adopt when using the IEEE 802.11a standard. The third column reflects the default values that these parameters adopt for the IEEE 802.11b standard and finally the fourth column reflects the default values that these parameters adopt for the IEEE 802.11g standard. Thus, in FIG. 2 it is observed that the default value for the parameter for the IEEE802.11a or g standard is CW_{MT}=15. The invention under no circumstance is restricted to these values. Employing the procedure described in the present invention, wireless network performance may be analyzed for different values of CW_{MT}.
As mentioned earlier, data packet transmission begins immediately when the backoff counter reaches zero. The data packet sent by the transmitter includes information on how long the channel will be occupied for the data transfer, including the receiver acknowledgement (ACK) of the successful data packet reception. If a collision occurs, all the terminals wait for a time period equivalent to the time required to transmit a data packet of maximum length over the wireless channel, plus a SIFS (Short InterFrame Space) time, the time required to transmit an ACK and finally a DIFS (Distributed coordination function InterFrame Space) time. The random access method described in the last four paragraphs is known as basic access.

A phenomenon that determines the performance of a wireless network is the existence of the hidden terminal. This phenomenon translates into the fact that terminals are hidden from each other, not being capable to listen to each others transmissions, except the AP which is capable of listening to all terminals and subsequently all terminals may hear the AP transmissions. FIG. 3 presents a schematic illustrating the hidden terminal phenomenon in a wireless network operating in infrastructure mode and multiple access. In this figure the AP (300) has a coverage area represented by the circle that surrounds it. This circle describes graphically the transmission range of this device. This circle covers all the terminals (310, 320 and 330) that form part of this model wireless network. This means that all the transmissions of the AP are perceived by the three terminals (310, 320 and 330).

The circle that represents the coverage area of terminal 310 covers the AP (300), but not the remaining terminals (320 and 330). This means that its transmissions may be perceived by the AP (300), but not so by the terminals 320 and 330. Consequently, terminal 310 is hidden from terminals 320 and 330.

The circle that represents the coverage area of terminal 320 covers the AP (300) and terminal 330, but does not cover terminal 310. This means that its transmissions may be perceived by the AP and by terminal 330, but not so by terminal 310. Consequently, terminal 320 is hidden from terminal 310, but is not hidden from terminal 330.

The circle that represents the coverage area of terminal 330 covers the AP (300) and terminal 320, but does not cover terminal 310. This means that its transmissions may be perceived by the AP and by terminal 320, but not so by terminal 310. Consequently, terminal 330 is hidden from terminal 310, but is not hidden from terminal 320.

The hidden terminal phenomenon may appear with the following conditions:

1.—When directive antennas are used at the terminals, with the purpose to increase the distance that the link covers. Typical antennas of this nature have a radiation pattern with an 8° to 120° coverage on the horizontal plane (this situation does not apply to a situation where the AP is provided with a directive antenna to restrict its coverage area, unless the AP has a directive antenna of dynamic nature (smart antenna)). Networks operating with the b/g variants of the IEEE 802.11 protocol are usually employed for longer distance links, given that their propagation conditions are more favorable since they utilize lower carrier frequencies than the IEEE 802.11a variant. Therefore, IEEE 802.11b/g wireless network variants are more likely to use directive antennas than the ones based on the IEEE 802.11a protocol.

2.—When two or more terminals are separated by a steel reinforced concrete wall, or by a wall that uses heat insulation material that contains some kind of metal or a wall covered by metal, obeying to some architectural design principle.

3.—When two terminals are separated by a distance close to the maximum covered by the device connected to the AP and are located opposite to each other respect to the AP.

The existence of the hidden terminal phenomenon is evidenced if the terminals that one suspects to be in this condition are configured in Ad-Hoc mode. Then a connectivity test signal (ping) is sent from one terminal to the other, being in proximity of each other. This test must have a positive outcome. Then, they are placed in their normal work positions and the process is repeated. If the terminals are hidden from each other no response will be registered. Once this procedure is complete, the terminals must be configured in infrastructure mode again.

The RTS/CTS mechanism is an attractive protocol to be used by terminals when in the presence of the hidden terminal phenomenon. It consists of the transmitter sending a request to send (RTS) packet, which is a small data packet, instead of directly sending the data packet when it is authorized to do so. This request includes enough information so that ail terminals that can receive this packet restrain themselves from transmitting for the time necessary to successfully transmit data. If all goes well, the receiver responds to this petition—after a SIFS time—with a CTS (Clear To Send) packet, which confirms the availability to receive the data packet. This confirmation informs, once again, the other terminals in the network the time that will be employed for the successful data transmission. After a SIFS time the transmitter sends the data which is responded by the receiver with an ACK after a SIFS time. A DIFS time after these events, all devices of the network have the opportunity to either transmit or decrement their backoff counter.

The RTS/CTS message exchange protocol is more complex and consumes more resources than the basic access mode, as may be derived from the previous description. Thus this mechanism is avoided when sending small data packets, even when in presence of the hidden terminal phenomenon.

Since the AP is the device that all the terminals use for exchanging messages when operating in infrastructure mode, this device will be configured in basic access mode. The explanation for this is quite simple: if a terminal can not detect the AP transmissions, it will not be able to be part of that network.

Another important aspect of this invention is the fact that an analytical model of the IEEE 802.11 protocol has been developed, which translates into a group of equations developed for situations with presence or absence of the hidden terminal. This model has been validated with simulations. These equations can be evaluated and graphed. The graphs may be interpreted to obtain configuration parameter values that optimize the performance of a network operating under full load conditions. Nonetheless, the effect a wireless network operating under normal conditions will also benefit from this optimized configuration, resulting in efficient channel utilization (throughput) and lower delays. These equations are part of the invention since they have not been previously reported.

These equations are defined by a series of parameters which have been alphabetically ordered in the following list. All the necessary parameters for this invention are included.
ACK is the packet size of the acknowledgement of a data transmission, sent by the destination node to the source node of the data packet, in bits.
AP Access Point.
CSMA/CA Carrier Sense Multiple Access with Collision Avoidance.
CTS Clear To Send, authorizes a packet transmission and is the packet size in bits.
CW is the initial contention window parameter of the device (MT or AP). When the device receives a data packet to transmit, it randomly chooses a number between [0, CWmin] to load to a transmission backoff counter. The counter is reduced by one unit at a time, every time an idle contention slot is detected. When the counter reaches 0 the packet is transmitted. If a collision occurs, the backoff counter is loaded again with a value chosen randomly between [0, 2ⁱ·CWmin], where i is a whole number that indicates how many retransmissions have been made. This proceeds until this value reaches CWmax, after which the initial backoff counter value is chosen in the [0, CWmax] range. The standard specifies that the process continues until the maximum number of permitted retransmissions has been reached (4 retransmissions for basic access mode and 7 for RTS/CTS). When the maximum number of retransmissions has been reached for a packet, it is discarded. CW is set back to CWmin after each successful packet transmission, or when the maximum number of retransmissions is reached and the packet is discarded.
CW_{AP} is the initial value of the configurable contention window value of the AP.
CW_{MT} is the initial value of the configurable contention window for each one of the terminals; all terminals are set to this value. IEEE 802.11b devices come by default with CW_{MT}=31. IEEE 802.11a and IEEE 802.11g devices come by default with CW_{MT}=15.
DCF Distributed Coordination Function, defines the random access or, basic access, mode of functioning with the IEEE 802.11 standard, based on CSMA/CA protocol.
DIFS DCF Inter Frame Space is the time that every device in a wireless network must remain idle after an ACK frame.
k is the number of collision slot intervals, o, that are counted during a data packet transmission (with their associated MAC and PHY layer headers) in presence of hidden terminals, when the data packet size is less than the RTS/CTS activation threshold. However, when the data packet exceeds the RTS/CTS activation threshold, the respective terminal sends a RTS packet (with its respective MAC and PHY layer headers) instead of the data packet and k, in this case, is the number of collision slot intervals, σ, that are counted for the transmission of the RTS packet.
L_{AP} average expected length of an IP data packet in bits, which will be transmitted by the MAC layer of the AP.
L_{MT} average expected length of an IP data packet in bits, which will be transmitted by the MAC layer of the terminals.
MAC refers to the number of bits that constitute the field associated to the necessary control information that needs to be transmitted. This information includes the MAC source and destination addresses, as well as an indication of the duration of the transmission associated to the length of the packet, among other things.
m_{AP} is the maximum number of times that the AP may retransmit when functioning in basic access mode (with the assumption that CW_{AP}=31) without exceeding the maximum window size 2ⁱ·CW_{AP}<CWmax, where i (i≦4) is the number of retransmissions, in basic access mode. However for the purpose of this invention, this value is not restricted to the ones specified by the standard.
m_{MT} is the maximum number of times that the terminal may retransmit when functioning in basic access mode (with the assumption that CW_{MT}=31) without exceeding the maximum window size 2ⁱ·CW_{MT}<CWmax, where i (i≦4) is the number of retransmissions, in basic access mode. When operating with the RTS/CTS mechanism i≦7. However for the purpose of this invention, this value is not restricted to the ones specified by the standard.
MaxPDUsize is the maximum data packet size that may be encapsulated in a MAC frame. For example, when using the IEEE 802.11b protocol this value is 2312 [bytes], as for the IEEE 802.11a and IEEE 802.11g protocols this value is 4095 [bytes].
MT refers to the mobile terminal.
n is the number of terminals present in the wireless network.
p_{AP} is the collision probability that an AP transmission experiments.
p_{MT} is the collision probability that a terminal transmission experiments.
PC_{AP} probability that a transmission of the AP experiments a collision.
PC_{MT} probability that a transmission of a terminal experiments a collision in absence of the hidden terminal phenomenon.
PC_{MT}(AP) probability that a terminal experiments a collision, in presence of the hidden terminal phenomenon, from the AP's point of view.
PC_{MT}(MT) probability that a terminal experiments a collision, in presence of the hidden terminal phenomenon, from the terminals point of view.
PI probability that the channel remains idle during a collision interval.
PLCP Physical Layer Convergence Protocol is the header of the PHY layer that all wireless transmissions have, in bits.
PS_{AP} probability that the AP experiments a successful transmission.
PS_{MT} probability that a terminal experiments a successful transmission.
R_{data} is the data transmission rate that the wireless network devices employ. IEEE 802.11b can use 11, 5.5, 2 or 1 Mbps data transmission rates, depending on the wireless link conditions.
R_{MAC} is the transmission rate that the wireless network devices use to transmit the MAC layer header. IEEE 802.11b uses either 2 or 1 Mbps, depending on the wireless link conditions.
R_{PCLP} is the transmission rate that the wireless network devices use to transmit the PHY layer header. IEEE 802.11b uses either 2 or 1 Mbps, depending on the wireless link conditions.
RTS Request To Send, is the request to send packet size in bits.
RTSThreshold activation threshold for the RTS/CTS mechanism, if a data packet exceeds this value in the data field of a MAC frame, then the 2-way-handshake (data packet-SIFS-ACK-DIFS) is replaced by the 4-way-handshake (RTS-SIFS-CTS-SIFS-ACK-SIFS-data packet-SIFS-ACK-DIFS).
r_{AP} is the maximum number of times that the AP may retransmit when operating in the basic access mode.
r_{MT} is the maximum number of times that a terminal may retransmit. When functioning in basic access mode this corresponds to 4 times and when employing the RTS/CTS mechanism it is 7 times. However for the purpose of this invention, this value is not restricted to the ones specified by the standard.
SE Signal Extension is the time (of 6(μs)) defined by the IEEE 802.11g standard that guarantees convolutional decoding after a packet transmission.
SIFS Short Inter Frame Space, is the time taken previous to an ACK and CTS frame.
S_{Uplink} is the maximum throughput that the network terminals may obtain when using the parameters specified by the standard and those configured by the network administrator.
S_{Downlink} is the maximum throughput that is obtained by downlink traffic from the AP, when using the parameters specified by the standard and those configured by the network administrator.
S_{Total}=S_{Uplink}+S_{Downlink} is the maximum global throughput that can be obtained from the network when using the parameters specified by the standard and those configured by the network administrator.
TC_{AP} time associated to the collision between the AP transmission with the terminal whom it wants to transmit to, from the AP's point of view.
TC_{MT} time associated to collision between terminal transmissions, from the terminals point of view, in absence of the hidden terminal phenomenon.
TC_{MT}(AP) time associated to the collision between terminal transmissions, from the AP's point of view, in presence of the hidden terminal phenomenon.
TC_{MT}(MT) time associated to the collision between terminal transmissions, from the terminals point of view, in presence of the hidden terminal phenomenon.
TI idle time of the wireless channel.
TS_{AP} time associated to a successful AP transmission.
TS_{MT} time associated to a successful terminal transmission.
δ time associated to the commutation from receiving to transmitting in a wireless device.
σ duration of a time slot during a collision interval.
τ_{AP} probability that the AP transmits.
τ_{MT} probability that a terminal transmits.

The equations model the network under full load (meaning that all terminals and the AP have something to transmit) steady state conditions. In particular, the steady state probability that the terminals and AP transmit, as a function of the contention window size and the probability that they transmitted previously experimenting a collision, is given by equations (1) to (4):

$$\begin{matrix}{τ}_{M T} = \frac{2 ( 1 - 2 {p}_{M T} ) ( 1 - {p}_{M T}^{{r}_{M T} + 1} )}{\begin{matrix}\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} ) +\end{matrix} \\ {\frac{C {W}_{M T}}{2} [ 2 {p}_{M T} ]}^{{m}_{M T} + 1} ( 1 - 2 {p}_{M T} )\end{matrix}} & ( 1 ) \\ {τ}_{M T} = \frac{2 ( 1 - 2 {p}_{M T} ) ( 1 - {p}_{M T}^{{r}_{M T} + 1} )}{\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} )\end{matrix}} & ( 2 ) \\ {τ}_{A P} = \frac{2 ( 1 - 2 {p}_{A P} ) ( 1 - {p}_{A P}^{{r}_{A P} + 1} )}{\begin{matrix}\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{A P P} + 1} ) +\end{matrix} \\ {\frac{C {W}_{A P}}{2} [ 2 {p}_{A P} ]}^{{m}_{A P} + 1} ( 1 - 2 {p}_{A P} )\end{matrix}} & ( 3 ) \\ {τ}_{A P} = \frac{2 ( 1 - 2 {p}_{A P} ) ( 1 - {p}_{A P}^{{r}_{A P} + 1} )}{\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{A P} + 1} )\end{matrix}} & ( 4 )\end{matrix}$$

Equation (1) expresses the probability that a wireless terminal transmits (τ_{MT}), whose initial and maximum contention window sizes CW_{MT} and CWmax have been set to values such that 4 retransmissions of a data packet (or 7 for a RTS packet) because no ACK (or CTS packets) have been received, that CWmax value has been reached and used more than once. This translates into that the value of r_{MT} is larger than m_{MT}.

Equation (2) establishes the probability that a wireless terminal transmits (τ_{MT}), whose initial and maximum contention window sizes CW_{MT} and CWmax have been set to values such that 4 retransmissions of a data packet (or 7 for a RTS packet) because no ACK (or CTS packets) have been received, that CWmax value has not been reached or used more than once. This translates into that the value of r_{MT} is equal or less than m_{MT}.

Equation (3) is valid to establish the probability that the AP transmits (τ_{AP}), whose initial and maximum contention window sizes CW_{AP} and CWmax have been set to values such that 4 retransmissions of a data packet (or 7 for a RTS packet), because no ACK (or CTS packets) have been received, that CWmax value has been reached and used more than once. This situation does not appear frequently, since normally a low value of CW_{AP} is chosen, but, if encountered, translates into that the value of r_{AP} is larger than m_{AP}.

Equation (4) is valid to establish the probability that the AP transmits (τ_{AP}), whose initial and maximum contention window sizes CW_{AP} and CWmax have been set to values such that 4 retransmissions of a data packet (or 7 for a RTS packet), because no ACK (or CTS packets) have been received, that CWmax value has not been reached or used more than once. This translates into that the value of r_{AP} is equal or less than m_{AP}.

Additionally, in absence of the hidden terminal, equations (5) and (6) are valid:

p_{AP}=1−(1−τ_{MT})ⁿ (5)

p_{MT}=1−(1−τ_{AP})(1−τ_{MT})ⁿ⁻¹ (6)

Equation (5) establishes the probability p_{AP} that an AP transmission coincides and collides with a terminal transmission.

Equation (6) establishes the probability p_{MT} that a terminal transmission collides.

Solving the set of equations (1) to (6), choosing appropriately among equations (1) and (2), as well as between equations (3) and (4), according to the criteria previously stated for n terminals, provide two values τ_{MT} and τ_{AP}, which are used to determine the total throughput (uplink and downlink) using equations (7) to (17), in absence of the hidden terminal. These two values may be obtained using software programs such as Matlab® or Maple®. It is important to point out that the results of these equations provide probabilities that the AP or terminal transmit. They do not consider the fact that packets have a specific destination address and can be in response to a packet sent previously in the other direction. Consequently, the results only indicate an attempt to use the channel, that can either be successful or not (collision).

$$\begin{matrix} {S}_{Total} = {S}_{Downlink} + {S}_{Uplink} \\ {S}_{Total} = \frac{{PS}_{A P} \cdot {L}_{A P} - {PS}_{M T} \cdot {L}_{M T}}{\begin{matrix}PI \cdot T I + {PS}_{A P} \cdot {TS}_{A P} + {PS}_{M T} \cdot {TS}_{M T} + \\ {PC}_{A P} \cdot {TC}_{A P} + {PC}_{M T} \cdot {TC}_{M T}\end{matrix}} & ( 7 ) \\ {PS}_{A P} = {{τ}_{A P} ( 1 - {τ}_{M T} )}^{n} & ( 8 ) \\ {TS}_{A P} = \frac{P L C P}{{R}_{P L C P}} + \frac{M A C}{{R}_{M A C}} + \frac{{L}_{A P}}{{R}_{data}} + δ + S I F S + \frac{P L C P}{{R}_{P L C P}} + \frac{ACK}{{R}_{M A C}} + δ + D I F S & ( 9 ) \\ {PS}_{M T} = n {{τ}_{M T} ( 1 - {τ}_{M T} )}^{n - 1} ( 1 - {τ}_{A P} ) & ( 10 ) \\ {TS}_{M T} = \frac{P L C P}{{R}_{P L C P}} + \frac{M A C}{{R}_{M A C}} + \frac{{L}_{M T}}{{R}_{data}} + δ + S I F S + \frac{PCLP}{{R}_{PCLP}} + \frac{ACK}{{R}_{M A C}} + δ + D I F S & ( 11 ) \\ {PC}_{A P} = {τ}_{A P} ( 1 - {[ 1 - {τ}_{M T} ]}^{n} ) & ( 12 ) \\ {TC}_{A P} = \frac{P L C P}{{R}_{P L C P}} + \frac{M A C}{{R}_{M A C}} + \frac{{L}_{A P}}{{R}_{data}} δ + S I F S + \frac{PCLP}{{R}_{PCLP}} + \frac{ACK}{{R}_{M A C}} + δ + D I F S & ( 13 ) \\ {PC}_{M T} = ( 1 - {τ}_{A P} ) [ 1 - {( 1 - {τ}_{M T} )}^{n} ] - n {{τ}_{M T} ( 1 - {τ}_{M T} )}^{n - 1} & ( 14 ) \\ {TC}_{M T} = \frac{P L C P}{{R}_{P L C P}} + \frac{M A C}{{R}_{M A C}} + \frac{{L}_{M T}}{{R}_{data}} + δ + S I F S + \frac{PCLP}{{R}_{PCLP}} + \frac{ACK}{{R}_{M A C}} + δ + D I F S & ( 15 ) \\ PI = ( 1 - {τ}_{A P} ) {( 1 - {τ}_{M T} )}^{n} & ( 16 ) \\ T I = σ & ( 17 )\end{matrix}$$

If the IEEE 802.11g protocol is employed then a SE (Signal Extension) of 6 μs is added to every packet that is sent through the wireless network that guarantees enough time for convolutional decoding of the transmitted OFDM symbols. Using equations (1) to (17) (choosing appropriately between equations (1) and (2), as well as between equations (3) and (4), as previously stated) and some software program such as Matlab® or Maple®, make it possible to calculate the throughput of a saturated wireless network operating in basic access mode, in absence of hidden terminals. The PLCP and MAC headers, which appear in equations (9), (11), (13) and (15), can be transmitted at different rates (R_{PLCP} and R_{MAC}) than the data rates (R_{data}).

The standard clearly states how this transmission is done, more than what has already been explained, thus no further details will be given.

It is possible that the network may have to function while in presence of hidden terminals. If this is the case, it is necessary to use different equations to some presented previously. Equations (1) to (4) (choosing adequately between equation (1) and (2), as well as between equations (3) and (4), as stated beforehand) are valid, but equations (5) to (8) must be replaced by equations (18) to (21).

$$\begin{matrix} {p}_{A P} = {τ}_{M T} & ( 18 ) \\ {p}_{M T} = 1 - ( 1 - {τ}_{A P} ) {( 1 - {τ}_{M T} )}^{( 2 k - 1 ) ( n - 1 )} & ( 19 ) \\ {S}_{Total} = {S}_{Downlink} + {S}_{Uplink} \\ {S}_{Total} = \frac{{PS}_{A P} \cdot {L}_{A P}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( A P ) {TC}_{M T} ( A P )\end{matrix}} + \frac{{PS}_{M T} \cdot {L}_{M T}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( M T ) {TC}_{M T} ( M T )\end{matrix}} & ( 20 ) \\ {PS}_{A P} = {{τ}_{A P} ( 1 - {τ}_{M T} )}^{n} & ( 21 )\end{matrix}$$

Equation (18) indicates the AP's steady state collision probability. Notice that this only depends on the fact that the destination terminal also transmits. Equation (19) expresses the collision probability of a terminal transmission. Equation (20) obtains global throughput, uplink and downlink, in presence of the hidden terminal phenomenon. Equation (21) indicates the probability of successful transmission by the AP in steady state.

In presence of the hidden terminal phenomenon, equation (9) still remains valid. However, equation (22) will be used in (20).

PS_{MT}=nτ_{MT}(1−τ_{MT})^{k(n-1)}(1−τ_{AP}) (22)

Additionally if the data packets transmitted by the terminals exceed the activation threshold of the RTS/CTS mechanism, (step 540), equation (23) is used in (20).

$${TS}_{M T} = 4 \cdot \frac{P L C P}{{R}_{P L C P}} + \frac{M A C}{{R}_{M A C}} + \frac{{L}_{M T}}{{R}_{data}} + 4 δ + 3 S I F S + \frac{R T S + C T S + ACK}{{R}_{M A C}} + D I F S \qquad ( 23 )$$

However, if the data packets transmitted by the terminals do not exceed the RTS/CTS activation threshold (packets smaller than the threshold—step 550), equation (24) is replaced in equation (20).

$${TS}_{M T} = \frac{P L C P}{{R}_{P L C P}} + \frac{M A C}{{R}_{M A C}} + \frac{{L}_{M T}}{{R}_{data}} + δ + S I F S + \frac{PCLP}{{R}_{PCLP}} + \frac{ACK}{{R}_{M A C}} + δ + D I F S \qquad ( 24 )$$

In presence of the hidden terminal phenomenon, it is necessary to replace equation (25) in equation (20).

PC_{AP}=τ_{AP}τ_{MT} (25)

Also, in the presence of the hidden terminal, equation (20) unfolds into the sum of two terms that, unlike equation (7), do not have the same denominator. This implies that equation (14) is no longer valid. The denominator of the first term of equation (20) is replaced by equation (26) and the denominator of the second term of equation (20) is replaced by equation (27).

PC_{MT}(AP)=(1−τ_{AP})[1−(1−τ_{MT})ⁿ−nτₜₘ(1−τ_{MT})ⁿ−nτₜₘ(1−τ_{MT})^{k(n-1)}] (26)

PC_{MT}(MT)=(1−τ_{AP})[τ_{MT}{1−(1−τ_{MT})^{k(n-1)}]} (27)

In presence of the hidden terminal, equation (15) is not valid either. The denominator of the first term of equation (20) is replaced by equation (28) and the denominator of the second term of equation (20) is replaced by equation (29), if the data packets sizes exceed the activation threshold of the RTS/CTS mechanism (step 540).

$$\begin{matrix}{TC}_{M T} ( A P ) = ( \frac{1 - {( 1 - {τ}_{M T} )}^{k ( n - 1 )}}{1 - {( 1 - {τ}_{M T} )}^{( n - 1 )}} - 1 ) \cdot ( \frac{1 - {( 1 - {τ}_{M T} )}^{k ( n - 1 )}}{1 - {( 1 - {τ}_{M T} )}^{k ( n - 1 )}} ) \cdot σ + 2 \frac{PCLP}{{R}_{PCLP}} + \frac{R T S}{{R}_{M A C}} + 2 δ + S I F S + D I F S & ( 28 ) \\ {TC}_{M T} ( M T ) = 2 \frac{PCLP}{{R}_{PCLP}} + \frac{R T S}{{R}_{M A C}} + \frac{C T S}{{R}_{M A C}} + S I F S + δ + D I F S & ( 29 )\end{matrix}$$

However, if in presence of the hidden terminal data packets have a smaller size than the activation threshold of the RTS/CTS mechanism, equation (15) is replaced by two terms in the denominators of equation (20). The denominator of the first term of equation (20) is replaced by equation (30) and the denominator of the second term of equation (20) is replaced by equation (31) if the data packets sizes are less than the activation threshold of the RTS/CTS mechanism.

$$\begin{matrix}{TC}_{M T} ( A P ) = ( \frac{1 - {( 1 - {τ}_{M T} )}^{k ( n - 1 )}}{1 - {( 1 - {τ}_{M T} )}^{( n - 1 )}} - 1 ) \cdot ( \frac{1 - {( 1 - {τ}_{M T} )}^{k ( n - 1 )}}{1 - {( 1 - {τ}_{M T} )}^{k ( n - 1 )}} ) \cdot σ + 2 \frac{PCLP}{{R}_{PCLP}} + \frac{M A C}{{R}_{M A C}} + \frac{{L}_{M T}}{{R}_{data}} + \frac{ACK}{{R}_{M A C}} + 2 δ + S I F S + D I F S & ( 30 ) \\ {TC}_{M T} ( M T ) = 2 \frac{PCLP}{{R}_{PCLP}} + \frac{M A C}{{R}_{M A C}} + \frac{{L}_{M T}}{{R}_{data}} + \frac{ACK}{{R}_{M A C}} + S I F S + δ + D I F S & ( 31 )\end{matrix}$$

When replacing the values of L_{AP}, L_{MT}, PLCP, R_{data}, R_{MAC}, and R_{PCLP} it is necessary to be careful, because these values depend on the physical (PHY) layer of the standard. For the IEEE 802.11b standard, these values may be obtained directly from FIG. 2 (third column) when transmitting at the highest rate. On the other hand, when using the IEEE 802.11a and IEEE 802.11g standards, the maximum transmission rate is 54 Mbps and the MAC and PLCP headers use a fixed time. It will be necessary to establish an equivalent packet size given that the bits are coded in symbols. The code rate when transmitting at 54 Mbps is 216 bits per symbol. To achieve this efficiency, pad bits are added to the packet so that the coding process may be performed. According to this, the size of a Protocol Data Unit (PDU) in bits is converted to symbols with the purpose to find how many pad bits are necessary to complete the whole number of bits needed for the last symbol. It is convenient to first define PDU_{AP}=L_{AP} and PDU_{MT}=L_{MT}, to later calculate the new adjusted values of L_{AP} and L_{MT} according to equations (32) and (33).

$$\begin{matrix}{L}_{A P} = [ ( \frac{P D {U}_{A P} + 24 bits}{216 bits \text{/} symbol} ) ] \cdot ( 216 bits \text{/} symbol ) & ( 32 ) \\ {L}_{M T} = [ ( \frac{P D {U}_{M T} + 24 bits}{216 bits \text{/} symbol} ) ] \cdot ( 216 bits \text{/} symbol ) & ( 33 )\end{matrix}$$

In these equations [•] is a function that returns the smallest integer value greater than or equal to its argument value. When transmitting at lower data rates, the standard indicates the values that should be used for PLCP, R_{PCLP}, R_{MAC} and R_{data}. In the specific case of the IEEE 802.11a and IEEE 802.11g standards the adequate symbol bit rate for R_{data}, can be obtained by consulting the standard.

The present invention is a procedure that allows configuring a random access IEEE 802.11 wireless network, operating in infrastructure mode (all terminals communicate exclusively with an AP (Access Point)), in such a way that throughput is optimized when the network is saturated, satisfying traffic characteristics, in presence or absence of the hidden terminal phenomenon and the number of terminals that communicate with the AP. It may be applied to networks that run a specific application or to those that have devices that run different applications. This procedure can be translated into a program that is operated by a wireless network administrator for network configuration. This program may also be incorporated into the configuration program of an AP and devices conforming to these standards. This invention can be applied to devices that act as AP's, such as a bridge, switch or router and the configuration can be manual or automatic, static or dynamic.

In case of a specific application, the procedure commences with verifying that the AP and terminals fulfill with the basic configuration, characterized by the infrastructure mode using the Distributed Coordination Function (DCF). Then the desired application is determined to establish the expected packet size on the uplink (from the terminals to the AP) and downlink (from the AP to the terminals). Afterward it is determined if the hidden terminal phenomenon exists and the standard that will be used (IEEE 802.11a, IEEE 802.11b, IEEE 802.11g or another from the same family). With these selections there is enough information to assign values to the parameters to a set of analytical equations and evaluate them for a number range of terminals and some initial contention window values of the AP. These evaluations can be graphed and subsequently interpreted to deduce the values of the configurable parameters RTSThreshold (activation threshold for the RTS mechanism) of the terminals and CW_{AP} (AP initial contention window size), for optimal network performance.

In this present invention the configuration procedure of a network running a single application (web based traffic, Voice over IP, FTP, data, etc) is demonstrated. However the invention is not restricted to this only. If a network consists of devices running multiple applications—subject to different requirements—is to be configured to optimize its performance, a similar procedure can be set up, based on a set of equations that are an extension of the ones described previously.

Therefore, the objective of this invention is to give a procedure to optimize the configuration parameters of a Wireless Local Area Network (WLAN), functioning with the IEEE 802.11 standard, in infrastructure and DCF mode that include these steps: Check the basic network configuration; Establish the traffic characteristics, according to the desired application(s); Determine if the hidden terminal phenomenon exists; Establish which IEEE 802.11 standard will be used; Graph a plurality of equations with the defined standard and parameters, obtaining behavior curves; Graph analysis of the obtained behavior curves; Determine the final configuration parameters.

The initial step of checking the basic network configuration, determines that the network will operate in infrastructure and DCF mode. In the step which determines the traffic characteristics, there are different options like web, FTP, VoIP, data or L_{AP} and L_{MT} parameters that can be set for the specific traffic that differ from the ones mentioned before.

The step that determines the existence of the hidden terminal phenomenon is performed by setting the RTSThreshold parameter of all the terminals that are part of the network to 100 bytes, and the RTSThreshold parameter for the AP is set to MaxPDUsize when this phenomenon is present. However the RTSThreshold parameter is set to MaxPDUsize for all terminals including the AP in absence of the hidden terminal phenomenon. In the step that determines the IEEE 802.11 standard to be employed, this also establishes the physical layer to be used.

Additionally, if the hidden terminal phenomenon should exist, the value of L_{MT} is compared to RTSThreshold of the terminals; if the value of L_{MT} is larger than the value of the RTSThreshold of the terminals, the equations that are used to graph behavior curves are (1) to (4) (choosing appropriately among equation (1) and (2) according to the criteria previously stated, as well as between equations (3) and (4)), (9), (16) to (23), (25) to (29) and (31); if the value of L_{MT} is smaller than the value of the RTSThreshold of the terminals, the equations that are used to graph behavior curves are (1) to (4) (choosing appropriately among equation (1) and (2) according to the criteria previously stated, as well as between equations (3) and (4)), (9), (16) to (22), (24) to (27) and (30) to (31); in absence of the hidden terminal phenomenon the equations that are used to graph behavior curves are (1) to (17) (choosing appropriately among equation (1) and (2) according to the criteria previously stated, as well as between equations (3) and (4)).

The graph analysis of the behavior curves of total traffic throughput, uplink and downlink, determine the values of CW_{AP} (AP initial contention window size) and n (the maximum number of terminals to be supported by the wireless network) that optimize network performance. A possible analysis considers the uplink and downlink throughput traffic curves for different CW_{AP} values, in such a way that the choice of the CW_{AP} value is determined by the curve that is above a data rate threshold per terminal, for the maximum number of desired terminals. Another alternative is that a proportion could exist between the coefficient L_{AP}/L_{MT} and the downlink and uplink traffic, establishing the maximum number of terminals supported by the wireless network that present a value equal or bigger than this coefficient. Thus, the configuration parameters that are determined are the CW_{AP} values that comply with the maximum number of established terminals that the network supports, according to the behavior curves of the wireless network.

Since the invention does not apply only to network devices running a single application, a similar configuration procedure can be established for a network running under more complex situations. As stated before, the set of equations can be extended to be able to analyze a network with different devices running different applications. The configuration procedure is similar to the one described, with the exception that more than one application has to be considered and devices running similar applications will have to be grouped to characterize them according to their traffic requirements.

This procedure can also be synthesized into a network configuration program. This program could be incorporated into the AP's configuration program, thus allowing the network administrator to optimize network performance with this computer tool.

### BRIEF DESCRIPTION OF THE DRAWINGS

FIG. 1 illustrates a network with 4 wireless terminals and an AP connected to a switch for Internet and a desktop computer.

FIG. 2 is a table that summarizes the relevant parameters of the IEEE 802.11a/b/g protocols, used in the evaluation of the set of equations.

FIG. 3 explains the hidden terminal phenomenon.

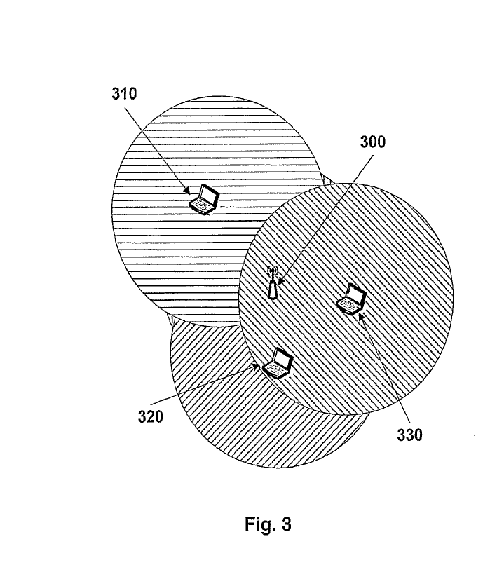

FIG. 4 shows a flow diagram illustrating the procedure to determine how to configure the wireless network parameters operating with the IEEE 802.11 protocol.

FIG. 5 is a flow diagram for the stage that determines the traffic characteristics.

FIG. 6 is a flow diagram for the hidden terminal phenomenon.

FIG. 7 is a flow diagram that explains the specific IEEE 802.11 standard choice.

FIG. 8 is a graph of curves obtained with the invention procedure.

FIG. 9 are graphs obtained for example 1.

FIG. 10 are graphs obtained for example 2.

FIG. 11 are graphs obtained for example 3.

FIG. 12 are graphs obtained for example 5.

FIG. 13 are graphs obtained for example 6.

### DETAILED DESCRIPTION OF THE PREFERRED EMBODIMENTS

A thorough description on how four terminals and an AP are configured, following the procedure given in this invention, will be described in the subsequent paragraphs. The terminals and AP are all functioning with the multiple access IEEE 802.11b protocol, in infrastructure and DCF mode, the terminals are close to the AP, the hidden terminal phenomenon is not present and the main application that the terminals will be using is VoIP (Voice over IP). The configuration procedure insures that the network optimizes its performance when it is saturated. Nonetheless, the effect of this optimized configuration also has benefits when the wireless network is not saturated, resulting in a better channel utilization (throughput) and smaller delays.

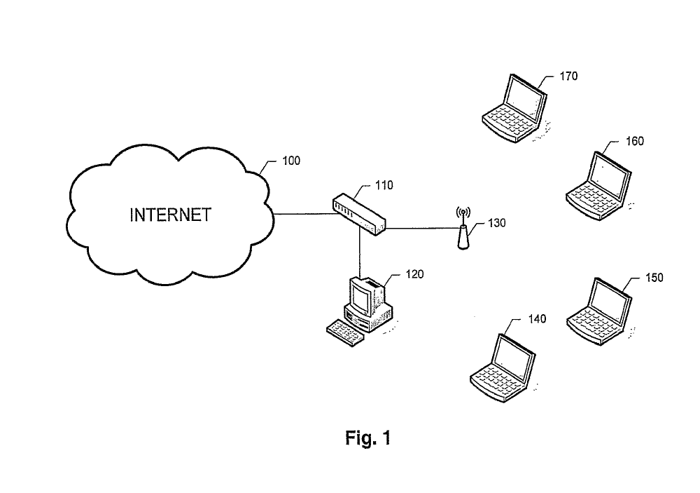

To be able to use this procedure, the devices must be set up accordingly to what is shown in FIG. 1. The AP (130) is configured by a desktop computer (120) connected by an Ethernet switch (110) and four terminals (140, 150, 160 and 170). The AP is configured by a program that resides in the desktop computer (120), program which is provided by the device manufacturer. On the other hand, the terminals (140, 150, 160 and 170) are configured using their resident configuration programs.

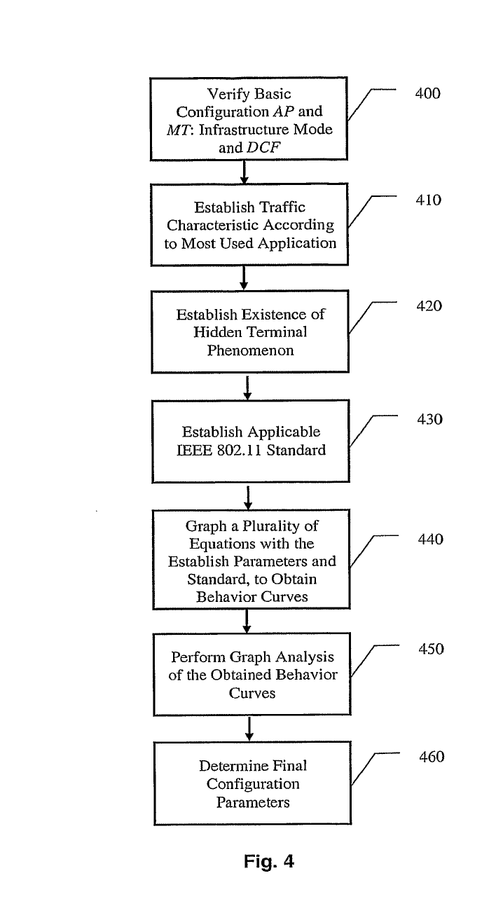

The steps to follow, to set the configurable parameters of the devices of the wireless network, are summarized in FIG. 4. The first step (400) consists of verifying that the devices that constitute the network are in the basic setup, this consists in verifying that the devices are set in infrastructure mode and multiple access or DCF (Distributed Coordination Function) mode.

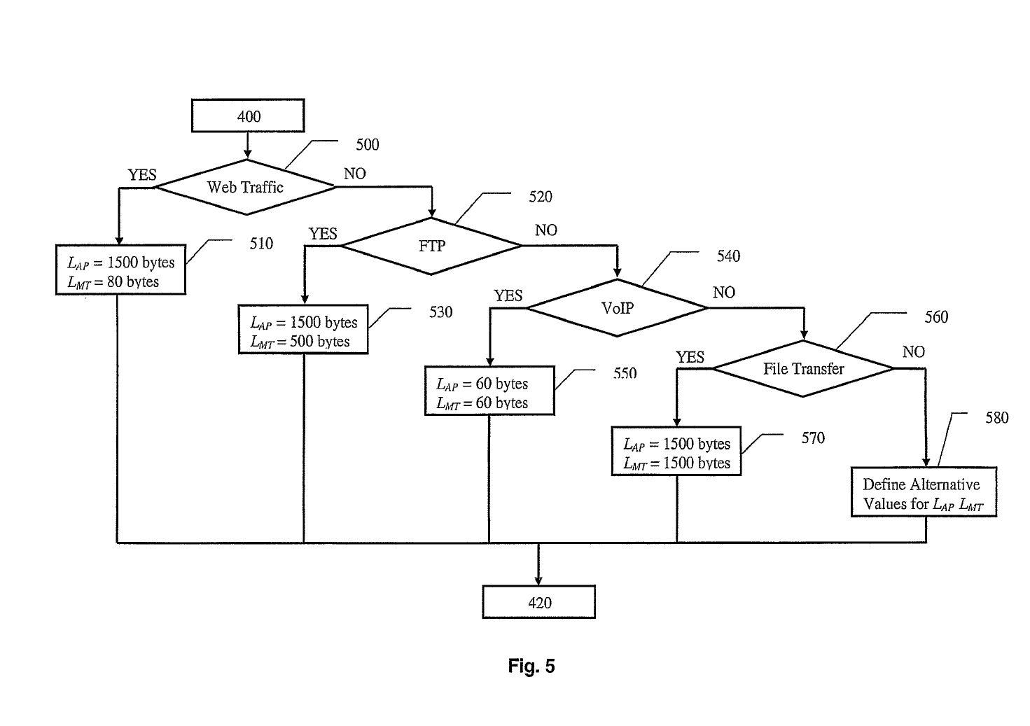

After this the traffic characteristics are established (410), according to the predominant application that the wireless network will be transmitting. One of the relevant aspects that determine the wireless network performance, operating with the IEEE 802.11 protocol, is the data packet size that circulates on it. If the data packets are small, performance will be low due to the large time dedicated to access control information of the total time of the shared channel. In particular, it is necessary to establish the average IP packet size transmitted by the AP (from now on denominated L_{AP}) and by the terminals (from now on denominated L_{MT})—These parameters are used to evaluate the equations that model network behavior. Although it is difficult to effectively predict the data packet sizes that are transmitted by the devices that compose the wireless network, it is possible to establish a predominant activity that the terminals occupy most of the time. FIG. 5 develops some examples related to step 410, although this description allows for other applications as well, which may be a mix of those presented in FIG. 5, for example.

It is possible to distinguish some applications in FIG. 5 and a specific traffic characteristic is associated to the uplink (from the terminals to the AP) and downlink (from the AP to the terminals). The relevant parameter to establish is the data packet size L_{AP} and L_{MT} associated to the specific traffic characteristics. The exact value of these parameters is not that relevant; the network behavior is not sensitive to slight variations of the values L_{AP} and L_{MT} may take, as it happens in real scenarios. The emphasis in this description is the procedure that allows tuning the easily configurable parameters of the IEEE 802.11 protocol that optimize performance. In particular, web Internet traffic (steps 500 and 510: terminals send small packets L_{MT}=80 bytes—related to menu selection operations or filling in small text areas—while the AP responds to these requests sending large packets L_{AP}=1500 bytes to refresh image displays), asymmetrical file transfers (steps 520 and 530: designated FTP traffic in this case because it can be associated to this activity (among others) in which the terminals send middle sized packets L_{MT}=500 bytes—related to packet transmission requests or refreshing active files—whereas the AP responds to these requests sending large packets (L_{AP}=1500 bytes) to refresh image displays), equal uplink and downlink traffic, differentiating between VoIP traffic (steps 540 and 550: Voice over IP, with delay and packet loss sensitive traffic originated from vocoders, such as the G.729 recommendation with packet sizes of approximately L_{AP}=L_{MT}=60 bytes) or file transfers (steps 560 and 570: large, but not delay sensitive files, L_{AP}=L_{MT}=1500 bytes). FIG. 5 allows for the use of other values for L_{AP} and L_{MT} (steps 500, 520, 540, 560 and 580), that can be associated to another desired application such as, videoconferences, video streaming, etc.

For the description of this example, in which the desired application is VoIP, the decision sequence that characterizes this kind of traffic is 500, 520, 540 and 550. This results in the following packet sizes: L_{AP}=L_{MT}=60 bytes which is the same for the terminals and AP (step 550).

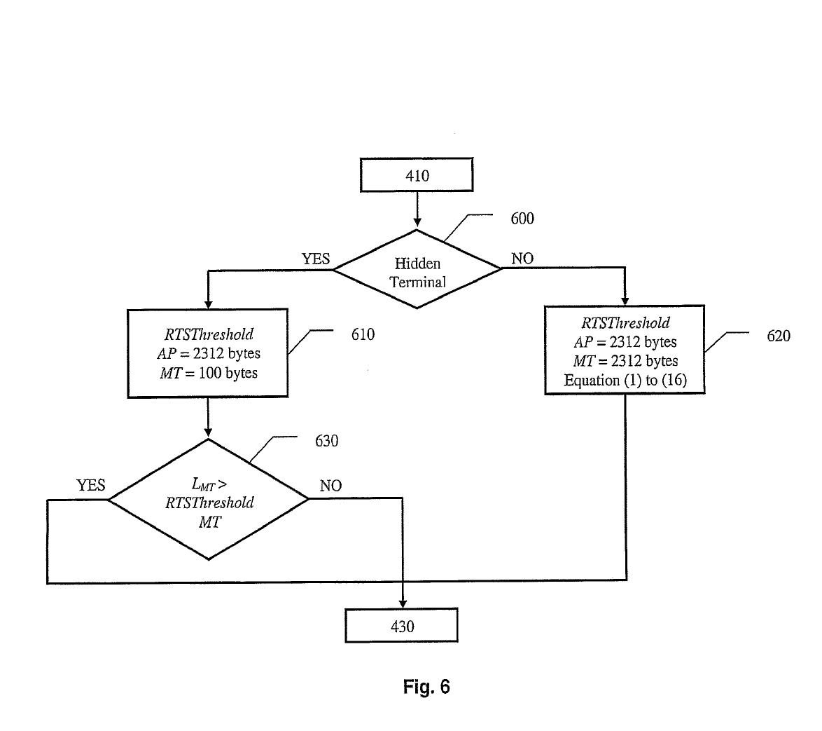

Following the procedure of FIG. 4, one must establish the existence of the hidden terminal phenomenon (420). FIG. 6 shows a flow diagram that explains what actions to take if the hidden terminal phenomenon is present or not (600). The decision results of FIG. 6 determine the activation threshold for the RTS/CTS mechanism (RTSThreshold) for the AP and terminals. The fact of detecting or not the existence of the hidden terminal phenomenon does not affect the configuration of the activation threshold of the RTS/CTS mechanism (RTSThreshold) of the AP, which is set to RTSThreshold=MaxPDUsize. This value is dependent of the specific IEEE 802.11 standard in use. On the other hand, the presence or not of the hidden terminal does affect the activation threshold of the RTS/CTS mechanism: RTSThreshold of the terminals. The applications that have been considered in the description of FIG. 5 generate different packet sizes. Applications that generate small packet sizes are web traffic (510) with L_{MT}=80 bytes and VoIP (550) with L_{MT}=60 bytes. Therefore, it is good practice to set the RTS/CTS activation threshold of the terminals to RTSThreshold=100 bytes or slightly bigger. There are recommendations that place this value in the 100 to 300 byte range, but in this description the 100 byte value will be employed, although this invention is not limited to this specific value. In fact, the effect of the RTS/CTS activation threshold for the terminals of this invention can be evaluated by replacing a chosen value in the appropriate equations. The procedure requires to determine whether L_{MT}>RTSThreshold (630) so as to pick the set of equations to be evaluated. This is a significant step of the configuration procedure, because it determines the set of equations that are used when in presence of the hidden terminal phenomenon.

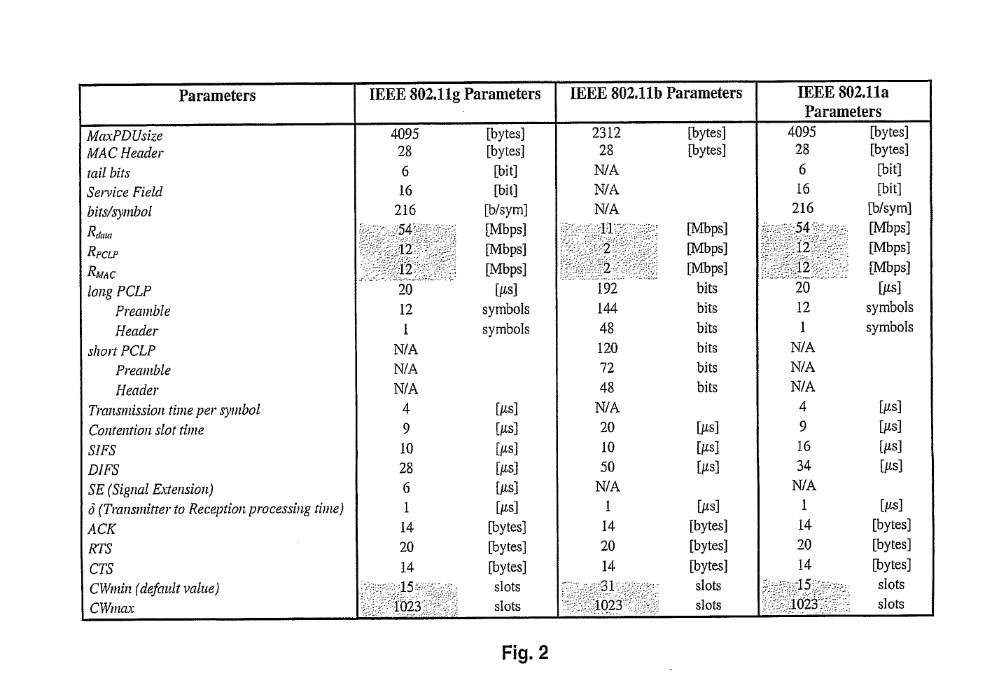

The example that is being explained considers that the wireless network that is being configured for the desired VoIP application has no hidden terminal present. Thus the RTS/CTS activation threshold of the AP and the terminals is set to a value of RTSThreshold=MaxPDUsize (steps 500 and 520). If we look ahead in this procedure, the value given by the IEEE 802.11b standard to the RTSThreshold=2312 bytes, as can be seen in FIG. 2. Since the AP and terminals are configured with this value, the wireless network operates in basic mode.

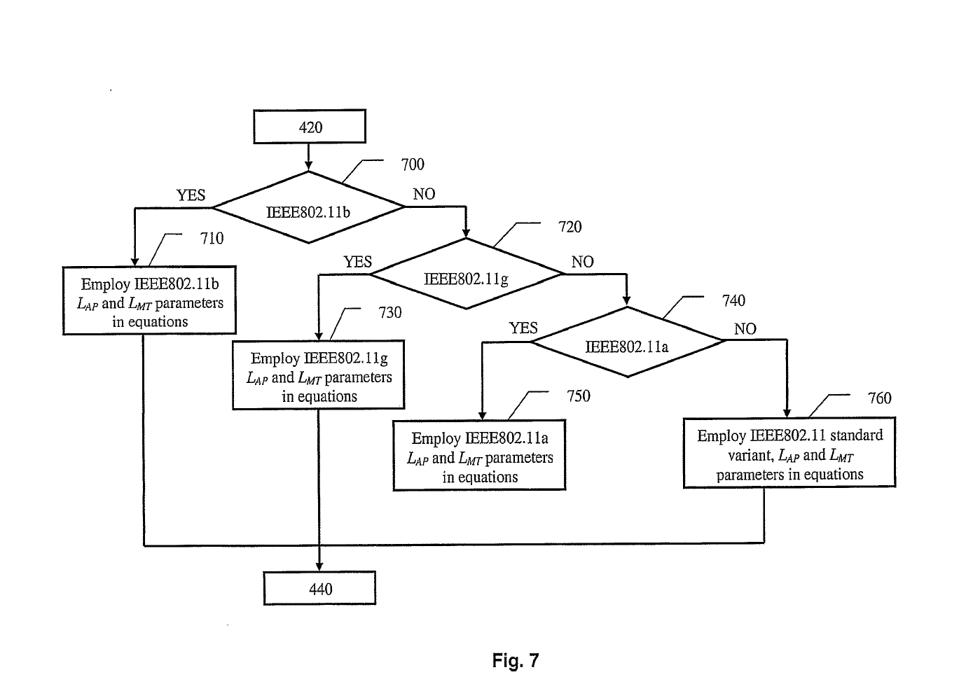

With these parameters determined we proceed to find the ones that are still missing to evaluate the set of equations. Next we need to choose the standard that is applicable (430). FIG. 7 presents a flow diagram with decisions for this stage.

If the IEEE 802.11b protocol is chosen (700 and 710), data packet values L_{AP}=L_{MT}=60 bytes (500, 520, 540 and 550) are chosen, according to the application. In absence of hidden terminals, the set of valid equations are (1) to (17) (choosing adequately between equation (1) and (2), as well as between equations (3) and (4), according to the criteria previously stated) using the parameters corresponding to the IEEE 802.11b standard (700 and 710) shown in the third column of FIG. 2.

However if the selected protocol is not IEEE 802.11b (700) and instead is the IEEE 802.11g protocol (720), then the valid set of equations for that standard must be employed, using the values of L_{AP} and L_{MT} chosen according to the application and the parameters corresponding to IEEE 802.11g standard (730).

If neither the IEEE 802.11b or IEEE 802.11g protocol are chosen, then the IEEE 802.11a standard parameter set will be selected (750), or another variant of the IEEE 802.11 standard (760). In this case, the corresponding valid set of equations are employed, using the values of L_{AP} and L_{MT} chosen according to the application and the parameters corresponding to IEEE 802.11a standard (750) or another IEEE 802.11 standard (760).

Returning to the example at hand, the wireless network is being configured for the desired VoIP application and in absence of the hidden terminal phenomenon. The packet size was determined by the desired application (500, 520, 540 and 550) with L_{AP}=L_{MT}=60 bytes. The absence of the hidden terminal phenomenon determines that the RTS/CTS activation threshold of the AP and the terminals is set to a value of RTSThreshold=MaxPDUsize (500 and 520). Since the terminals and AP are configured to this value, the wireless network is operating in basic access mode. Therefore, the parameters obtained from these previous steps in conjunction with the parameters of the chosen standard can be replaced in equations (1) to (17) (choosing adequately between equation (1) and (2), as well as between equations (3) and (4), according to previously stated criteria). Additionally it is known that the terminals are placed close to the AP, thus the data transmission rate is of 11 Mbps and the MAC and PLCP headers at 2 Mbps.

RTSThreshold=MaxPDUsize=2.312 bytes

PCLP=120 bits

MAC=28 bytes

ACK=14 bytes

R_{PCLP}=R_{MAC}=2 Mbps

R_{data}=11 Mbps

SIFS=10 fis

DIFS=50 μs

σ=20 μs

δ=1 μs

CW_{MT}=31

CW_{AP} is analyzed for the following values 31, 15, 7 and 3

n, number of terminals, is varied from 1 to 20

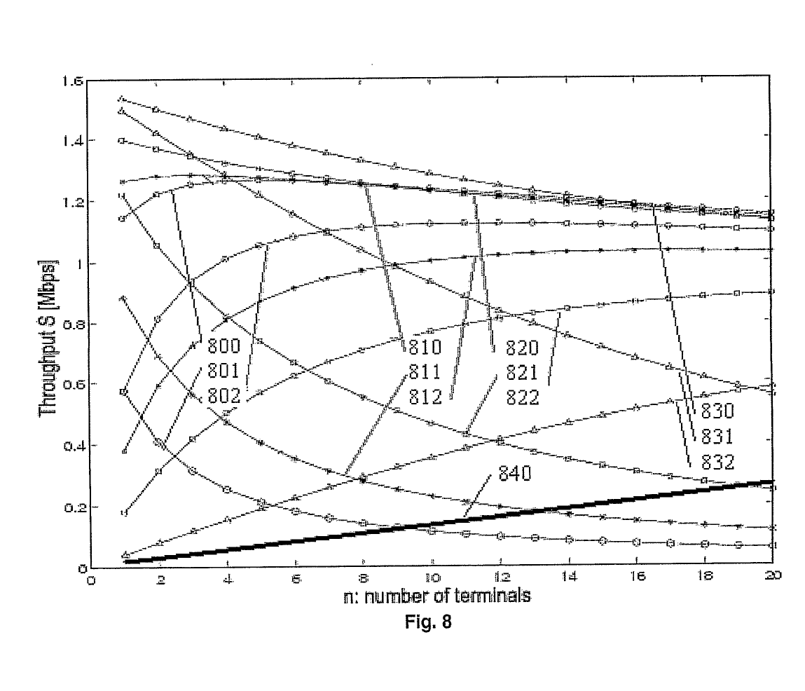

Using these parameter values and employing a calculus software program such as MatLab® or Maple® it is possible to obtain FIG. 8, as indicated in step 440. In FIG. 8, curves 800, 801 and 802 represent total, downlink and uplink throughput respectively with CW_{AP}=31. Curves 810, 811 and 812 represent total, downlink and uplink throughput respectively with CW_{AP}=15. Curves 820, 821 and 822 represent total, downlink and uplink throughput respectively with CW_{AP}=7. Curves 830, 831 and 832 represent total, downlink and uplink throughput respectively with CW_{AP}=3. Additionally curve 840 has been plotted, which represents the contribution that each terminal has over uplink or downlink traffic; voice is coded using a vocoder with a 12 kbps average (ITU-T recommendation for high quality transmissions with the IP G.729 vocoder). These curves will be analyzed to determine the most adequate value for CW_{AP}, as stipulated in step 450.

The curve analysis for other applications differs slightly and will be explained in the following examples. They base themselves on finding a balance between the uplink and downlink traffic given by the L_{AP}/L_{MT} relationship and the number of terminals that make up the network.

The uplink and downlink traffic curves in FIG. 8 vary noticeably with the number of terminals, but have a less notorious effect on the total throughput curves (800, 810, 820 and 830). To satisfy the wireless network traffic requirements it is necessary to comply with the requirement that both the uplink and downlink traffic must be over curve 840, which is complied for 13 or less terminals with CW_{AP}=15. It is possible to attend a higher number of terminals (19 terminals) if CW_{AP}=7 is selected and even more terminals if CW_{AP}=3. Consequently it is recommended to set the AP's initial contention window size CW_{AP} to 15, 7 or 3 depending on the number of terminals that are present in the wireless network. Given that the number of terminals in this example is 4, the parameter CW_{AP} may be set to 15, 7 or 3. The use of the lowest value will provide smaller delays for the voice communication transmission.

Thus, the procedure has been completed for a wireless network composed of 13 or less terminals and one AP, all functioning with the IEEE 802.11b standard, with multiple access (DCF) in infrastructure mode, in absence of the hidden terminal, and the most used application is VoIP and the terminals are close to the AP in such a way that they transmit at a maximum rate of 11 Mbps. The RTS/CTS activation threshold of the AP and terminals must be set to 2312 bytes and the AP's initial contention window size is set to CW_{AP}= 3 (step 460).

### Example 1

### Symmetric Data Transfer, No Hidden Terminal Phenomenon, IEEE 802.11b Protocol

This case shows how to configure a multiple access wireless network operating with the IEEE 802.11b standard, in absence of the hidden terminal phenomenon, with a symmetrical data transfer. Packets are of the maximum size of an Ethernet network, to which the AP is connected. Excellent transmission conditions exist for the wireless links.

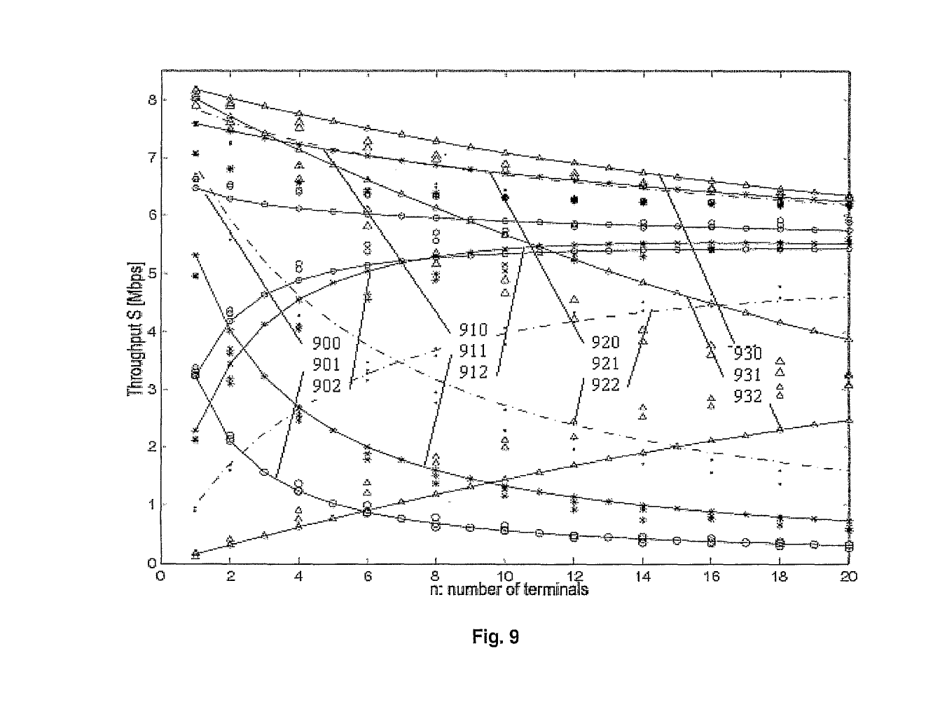

Following the same procedure described before, the basic configuration is first checked (400) and the AP and the terminals are set in infrastructure and DCF mode (410). The traffic characteristic is established according to the main application in use (430), in this case L_{AP}=L_{MT}=1500 bytes (500, 520, 540, 560 and 570). Since the hidden terminal phenomenon is not present the RTS/CTS activation threshold of the AP and terminals are set to RTSThreshold=2312 bytes (600 and 620) in a network modeled by equations (1) to (17) (choosing adequately between equation (1) and (2), as well as between equations (3) and (4), as previously stated) operating with the IEEE 802.11b protocol (700 and 710). Additionally, the terminals are close enough to the AP to work at the maximum data transmission rate of 11 Mbps and the MAC and PLCP headers are transmitted at 2 Mbps. Evaluating the equations with a calculus software program such as MatLab® or Maple®, with CW_{AP}=31, 15, 7 and 3 and varying the number of terminals from 1 to 20, FIG. 9 is obtained as step 440 establishes. This figure presents analytical curves obtained by the evaluation of the set of equations which are validated by simulations, performed by Network Simulator 2®(ns2). These simulations are indicated in the figure by points close to the respective analytical curves and represent the upper and lower 95% confidence intervals of even numbers of terminals.

In FIG. 9, curves 900, 901 and 902 represent total, downlink and uplink throughput respectively with CW_{AP}=31. Curves 910, 911 and 912 represent total, downlink and uplink throughput respectively with CW_{AP}=15. Curves 920, 921 and 922 represent total, downlink and uplink throughput respectively with CW_{AP}=1. Curves 930, 931 and 932 represent total, downlink and uplink throughput respectively with CW_{AP}=3.

To find the most appropriate value of CW_{AP}, two things need to be considered: the AP should be capable of sending at least as many packets to the terminals as these are capable of sending in the opposite direction and that traffic increases when the value of CW_{AP} diminishes. Since L_{AP}=L_{MT}=1500 bytes, a balance must be sought between the uplink and downlink throughput. This parity of values is achieved with CW_{AP}=31 for one terminal connected to the AP, CW_{AP}=15 for two terminals, CW_{AP}=7 for three to seven terminals and CW_{AP}=3 for more than eight terminals connected to the AP. This discards CW_{AP}=31 (curiously this is the default value that is set in most AP's) and leaves the possibility to choose any of the other values. CW_{AP}=15 is not a good choice either since normally more than two terminals are connected to a wireless network. The value CW_{AP}=1 or 3 seems to be a good choice.

When selecting CW_{AP}=3, both VoIP and data transfers applications comply well for a good network performance. Both show symmetric traffic patterns and the main difference is packet size.

### Example 2

### Asymmetric Data Transfer (Web Traffic), No Hidden Terminal Phenomenon, IEEE 802.11b Protocol

This case shows how to configure a multiple access wireless network operating with the IEEE 802.11b standard, in absence of the hidden terminal phenomenon, with an asymmetrical data transfer, which is a characteristic of web traffic. Terminals establish an excellent wireless link with the AP.

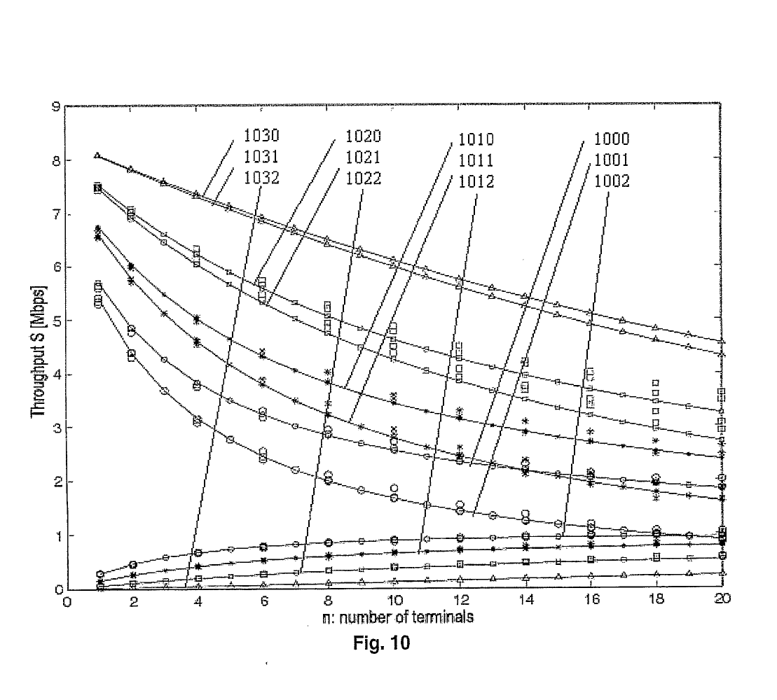

Following the same procedure described before, the basic configuration is first checked (400) and the AP and the terminals are set in infrastructure and DCF mode (410). The traffic characteristic is established according to the main application in use (430), in this case L_{AP}=1500 bytes and L_{MT}=80 bytes (500 and 510). Since there is no hidden terminal, the RTS/CTS activation threshold of the AP and terminals is set to RTSThreshold=2312 bytes (600 and 620). The network will be modeled by equations (1) to (17) (choosing adequately between equation (1) and (2), as well as between equations (3) and (4), as previously stated) operating with the IEEE 802.11b protocol (700 and 710). Additionally, the terminals are close enough to the AP to work at the maximum data transmission rate of 11 Mbps and the MAC and PLCP headers are transmitted at 2 Mbps. Evaluating the equations with a calculus software program such as MatLab® or Maple®, with CW_{AP}=31, 15, 7 and 3 and varying the number of terminals from 1 to 20, FIG. 10 is obtained, as step 440 establishes. This figure presents analytical curves obtained by the evaluation of the set of equations which are validated by simulations, performed by Network Simulator 2®(ns2). These simulations are indicated in the figure by points close to the respective analytical curves and represent the upper and lower 95% confidence intervals of even numbers of terminals.

In FIG. 10, curves 1000, 1001 and 1002 represent total, downlink and uplink throughput respectively with CW_{AP}=31. Curves 1010, 1011 and 1012 represent total, downlink and uplink throughput respectively with CW_{AP}=15. Curves 1020, 1021 and 1022 represent total, downlink and uplink throughput respectively with CW_{AP}=7. Curves 1030, 1031 and 1032 represent total, downlink and uplink throughput respectively with CW_{AP}=3.

To find the most appropriate value of CW_{AP} it is necessary to observe two things: the AP should be capable of sending at least as many packets to the terminals as these are capable of sending in the opposite direction, also, traffic handling capability increases as the value of CW_{AP} diminishes. In this case packet sizes are quite different, L_{AP}=1500 bytes and L_{MT}=80 bytes. The downlink traffic should be ({1500 bytes}/{80 bytes}=18.75) almost 19 times larger than the uplink traffic. Since the uplink traffic is almost independent of the number of terminals and taking the highest uplink traffic value as reference (0.3 Mbps), the only configuration that results acceptable for a maximum number of 20 terminals is CW_{AP}=3. This can be explained by knowing that the downlink traffic must surpass 5.6 Mbps (0.3 Mbps·18.75≈5.6 Mbps). Only using CW_{AP}=1 complies with this relationship when there are less than 5 terminals in the wireless network.

This discards CW_{AP}=31, curiously this is the default value that is set in most AP's. CW_{AP}=3 is a good choice for this example, and considering the last two examples, this value also resulted in an adequate selection.

### Example 3

### Asymmetric Data Transfer (FTP Traffic), Absence of Hidden Terminal Phenomenon, IEEE 802.11b Protocol

This case shows how to configure a multiple access wireless network operating with the IEEE 802.11b standard, in absence of the hidden terminal phenomenon, with an asymmetrical data transfer, which is a characteristic of FTP traffic. Terminals establish an excellent wireless link with the AP.

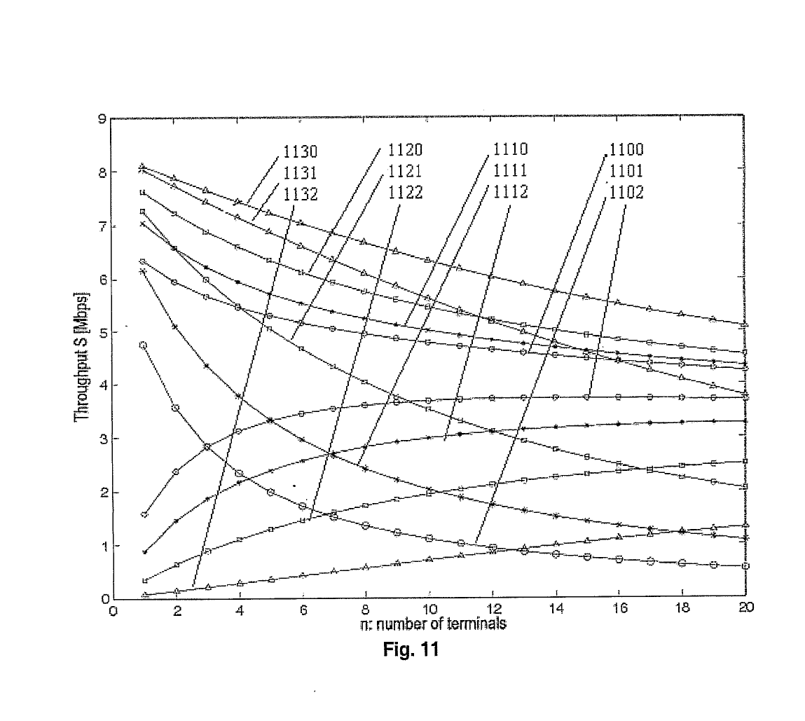

Following the same procedure described before, the basic configuration is first checked (400) and the AP and the terminals are set in infrastructure and DCF mode (410). The traffic characteristic is established according to the main application in use (430), in this case L_{AP}=1500 bytes and L_{MT}=500 bytes (500, 520 and 530). Since the hidden terminal phenomenon is not present, the RTS/CTS activation threshold of the AP and terminals is set to RTSThreshold=2312 bytes (600 and 620) in a network modeled by equations (1) to (17) (choosing adequately between equation (1) and (2), as well as between equations (3) and (4), according to the criteria previously stated) operating with the IEEE 802.11b protocol (700 and 710). Additionally, the terminals are close enough to the AP to work at the maximum data transmission rate of 11 Mbps and the MAC and PLCP headers are transmitted at 2 Mbps. Evaluating the equations with a calculus software program such as MatLab® or Maple®, with CW_{AP}=31, 15, 7 and 3 and varying the number of terminals from 1 to 20, FIG. 11 is obtained as step 440 establishes. This figure presents analytical curves obtained by the evaluation of the set of equations presented in this invention.

In FIG. 11, curves 1100, 1101 and 1102 represent total, downlink and uplink throughput respectively with CW_{AP}=31. Curves 1110, 1111 and 1112 represent total, downlink and uplink throughput respectively with CW_{AP}=15. Curves 1120, 1121 and 1122 represent total, downlink and uplink throughput respectively with CW_{AP}=7. Curves 1130, 1131 and 1132 represent total, downlink and uplink throughput respectively with CW_{AP}=3.

To find the most appropriate value of CW_{AP} it is necessary to observe two things: the AP should be capable of sending at least as many packets to the terminals as these are capable of sending in the opposite direction, also, traffic handling capacity increases as the value of CW_{AP} decreases. In this case packet sizes are slightly different, L_{AP}=1500 bytes and L_{MT}=500 bytes. The downlink traffic should be ({1500 bytes}/{500 bytes}=3) 3 times larger than the uplink traffic. This relationship of values is achieved with CW_{AP}=31 for one terminal connected to the AP, CW_{AP}=15 for two terminals, CW_{AP}=7 for three to seven terminals and CW_{AP}=3 for more than eight terminals connected to the AP (up to twenty terminals). This discards CW_{AP}=31 (curiously this is the default value that is set in most AP's) and leaves the possibility to choose any of the other values. CW_{AP}=15 is not a good choice either since normally more than two terminals are connected to a wireless network. The value CW_{AP}=7 or 3 seems to be a good choice.

### Example 4

### No Defined Application, Absence of Hidden Terminal Phenomenon, IEEE 802.11b Protocol

All previous examples of wireless networks operating with the IEEE 802.11b protocol configured in infrastructure and DCF mode conclude that configuring CW_{AP}=3 is a good choice, independent of traffic characteristics, in absence of the hidden terminal phenomenon. Therefore it is possible to find that by means of applying the configuration procedure described, that a given solution may be applied for more than one application. This may also happen under mixed traffic conditions.

### Example 5

### Symmetric Data Transfer, Presence of the Hidden Terminal Phenomenon, IEEE 802.11b Protocol

This case shows how to configure a multiple access wireless network operating with the IEEE 802.11b standard, in presence of the hidden terminal phenomenon, with a symmetrical data transfer in which the packets are of the maximum size which an Ethernet network establishes with the AP. Terminals establish an excellent wireless link with the AP.

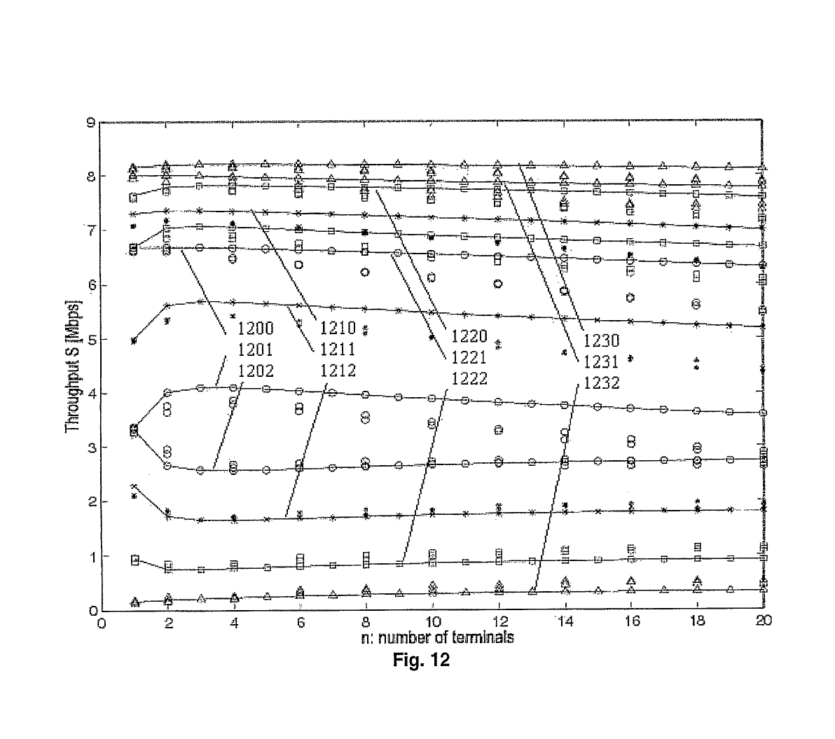

Following the same procedure described before, the basic configuration is first checked (400) and the AP and the terminals are set in infrastructure and DCF mode (410). The traffic characteristic is established according to the main application in use (430), in this case L_{AP}=L_{MT}=1500 bytes (500, 520, 540, 560 and 570). Since the hidden terminal phenomenon is present the RTS/CTS activation threshold of the AP is set to RTSThreshold=2312 bytes and the terminals to RTSThreshold=100 bytes (600 and 610). In addition, L_{MT}>RTSThreshold and the terminals are close enough to the AP to work at the maximum data transmission rate of 11 Mbps and the MAC and PLCP headers are transmitted at 2 Mbps, the network is also operating with the IEEE 802.11b protocol (700 and 710). These values are replaced in equations (1) to (4) (choosing adequately between equation (1) and (2) according to the criteria previously stated, as well as between equations (3) and (4)), (9), (16) to (23) and (25) to (29). The set of equations can be evaluated with a calculus software program such as MatLab® or Maple®, with CW_{AP}=31, 15, 7 and 3 and varying the number of terminals from 1 to 20. FIG. 12 is obtained in this manner as step 440 establishes. This figure presents analytical curves obtained by the evaluation of the set of equations which are validated by simulations, performed by Network Simulator 2® (ns2). These simulations are indicated in the figure by points close to the respective analytical curves and represent the upper and lower 95% confidence intervals of even numbers of terminals.

In FIG. 12, curves 1200, 1201 and 1202 represent total, downlink and uplink throughput respectively with CW_{AP}=31. Curves 1210, 1211 and 1212 represent total, downlink and uplink throughput respectively with CW_{AP}=15. Curves 1220, 1221 and 1222 represent total, downlink and uplink throughput respectively with CW_{AP}=7. Curves 1230, 1231 and 1232 represent total, downlink and uplink throughput respectively with CW_{AP}=3.

To find the most appropriate value of CW_{AP} it is necessary to observe two things: it is desired that the AP be capable of sending at least as many packets to the terminals as these are able of sending in the opposite direction, and that traffic capacity increases when diminishing the value of CW_{AP}. Since L_{AP}=L_{MT}=1500 bytes, a balance must be sought between the uplink and downlink throughput. This parity of values is best achieved with CW_{AP}=31 for any number of terminals from 1 to 20. Smaller values of CW_{AP} hinder the uplink traffic and do not reach the desired relationship between uplink and downlink traffic.

### Example 6

### Symmetric Data Transfer, Absence of the Hidden Terminal Phenomenon, IEEE 802.11a protocol

This case shows how to configure a multiple access wireless network operating with the IEEE 802.11a standard, in absence of the hidden terminal phenomenon, with a symmetrical data transfer in which the packets are of the maximum size which an Ethernet network establishes with the AP. Terminals establish an excellent wireless link with the AP.

Following the same procedure described before, the basic configuration is first checked (400) and the AP and the terminals are set in infrastructure and DCF mode (410). The traffic characteristic is established according to the main application in use (430), in this case L_{AP}=L_{MT}=1500 bytes (500, 520, 540, 560 and 570). Since the hidden terminal phenomenon is not present, the RTS/CTS activation threshold of the AP and terminals are set to RTSThreshold=MaxPDUsize (600 and 620). Additionally, the terminals are close enough to the AP to work at the maximum data transmission rate of 54 Mbps.

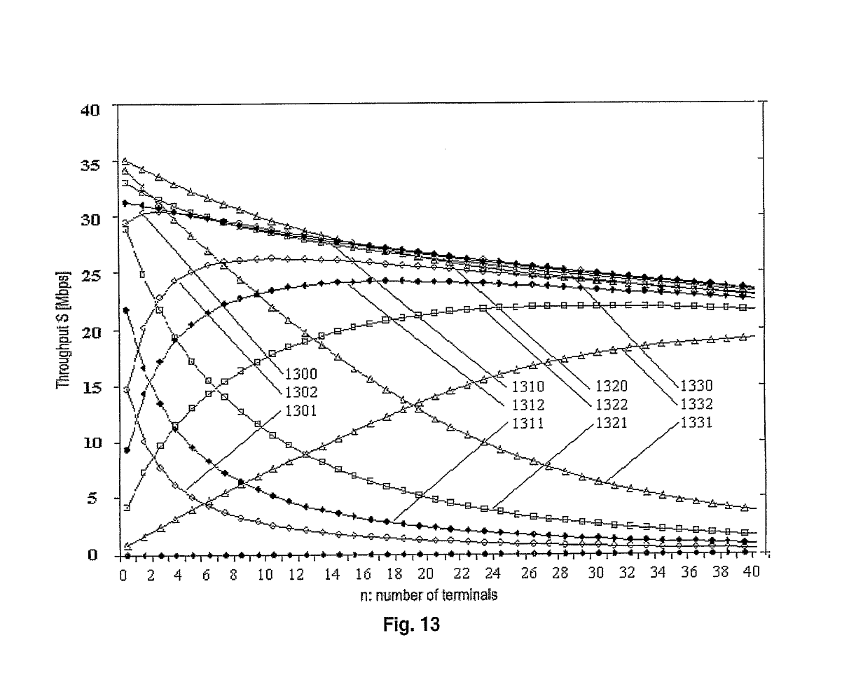

An equivalent packet size needs to be established in this case, since the IEEE 802.11a protocol is more efficient by transmitting the data bits in coded symbols. The code rate is 216 bits per symbol to achieve a 54 Mbps transmission rate. To reach this efficiency, pad bits are added to the packet so that the coding can be performed. According to this, the packet size is L_{AP}=L_{MT}=┌((1500 bytes)(8 bit/bytes)+24 bits)/(216 bits/symbol)┐(216 bits/symbol)/(8 bits/bytes)=1512 bytes=12096 bits, where PI is a function that returns the smallest integer value greater than or equal to its argument value. Replacing the values of L_{AP}. L_{MT} and the rest of the standard parameters in equations (1) to (17) (choosing adequately between equation (1) and (2) according to the criteria previously stated, as well as between equations (3) and (4)) with CW_{AP}=31, 15, 7 and 3 and varying the number of terminals from 1 to 40 gives as a result FIG. 13 as step 440 establishes. These equations can be evaluated with a calculus software program such as MatLab® or Maple®. For this particular figure, the value of CW_{MT}=31, which is also not the default IEEE 802.11a value.

In FIG. 13, curves 1300, 1301 and 1302 represent total, downlink and uplink throughput respectively with CW_{AP}=31. Curves 1310, 1311 and 1312 represent total, downlink and uplink throughput respectively with CW_{AP}=15. Curves 1320, 1321 and 1322 represent total, downlink and uplink throughput respectively with CW_{AP}=7. Curves 1330, 1331 and 1332 represent total, downlink and uplink throughput respectively with CW_{AP}=3.

It is important to point out that throughput is much higher than IEEE 802.11b, due to the high data transmission rates that IEEE 802.11a achieves. To find the most appropriate value of CW_{AP} it is necessary to observe two things: it is desired that the AP be capable of sending at least as many packets to the terminals as these are capable of sending in the opposite direction, and that traffic capacity increases when diminishing the value of CW_{AP}. Since L_{AP}=L_{MT}=1500 bytes, a balance must be sought between the uplink and downlink throughput. This parity of values is achieved with CW_{AP}=31 for one terminal connected to the AP, CW_{AP}=15 for two terminals, CW_{AP}=7 for three to seven terminals and CW_{AP}=3 for eight to nineteen terminals connected to the AP. This discards CW_{AP}=31, CW_{AP}=15 and leaves CW_{AP}=3 as a good choice.

What is claimed is:

1. A procedure to optimize configuration parameters of a wireless local area network, operating with the IEEE 802.11 protocol in infrastructure and DCF (Distributed Coordination Function) mode, wherein the procedure compromising the following stages:
Verify the basic network configuration;
Establish the traffic characteristics, according to the desired application;
Determine if the hidden terminal phenomenon exists;
Establish which IEEE 802.11 standard will be used;
Graph a plurality of equations with the defined standard and parameters, obtaining behavior curves;
Graph analysis of the obtained behavior curves; and
Determine the final configuration parameters.

2. The method of claim 1, wherein the stage of verifying the basic network configuration compromises that it operates in infrastructure and DCF mode.

3. The method of claim 1, wherein the stage of establishing the traffic characteristics compromises web traffic, FTP traffic, VoIP traffic, data transfer traffic or alternative traffic.

4. The method of claim 1, wherein the stage of determining the existence of the hidden terminal phenomenon compromises setting the AP and terminals RTSThreshold parameter that are part of the network; where RTSThreshold is the RTS/CTS mechanism (Request To Send/Clear To Send) activation threshold.

5. The method of claim 1, wherein the stage of determining the IEEE 802.11 standard compromises the physical layer that will be employed.

6. The method of claim 3, wherein traffic is determined by the L_{AP} and L_{MT} parameters; wherein L_{AP} is the average expected length of an IP packet, that will be transmitted by the MAC layer of the AP; wherein L_{MT} is the average expected length of an IP packet, that will be transmitted by the MAC layer of the terminals.

7. The method of claim 6, wherein this method can be extended to traffic patterns where terminals may be grouped conforming to L_{MT1}, L_{MT2}, . . . packet sizes, according to the application that is running on individual terminals that are part of the wireless network.

8. The method of claim 4, wherein the RTSThreshold parameter of all the network terminals is set to 100 bytes, but not restricted to this exact value and the RTSThreshold of the AP is set to the MaxPDUsize value, which is the maximum data packet size that can be encapsulated in a MAC frame.

9. The method of claim 4, wherein the RTSThreshold parameter of the AP and the terminals are set to MaxPDUsize in absence of the hidden terminal phenomenon; wherein MaxPDUsize is the maximum data packet size that can be encapsulated in a MAC frame.

10. The method in claim 7, wherein the value of L_{MT} is compared to the value of RTSThreshold of the terminals; wherein L_{MT} is the average expected length of an IP packet that will be transmitted by the MAC layer of the terminals.

11. The method in claim 5, wherein if the value of L_{MT} is larger than the RTSThreshold value of the terminals the equations to graph behavior curves are the following:
$${τ}_{MT} = \frac{2 ( 1 - 2 {p}_{MT} ) ( 1 - {p}_{MT}^{{r}_{MT} + 1} )}{\begin{matrix}\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} ) +\end{matrix} \\ {\frac{{CW}_{MT}}{2} [ 2 {p}_{MT} ]}^{{m}_{MT} + 1} ( 1 - 2 {p}_{MT} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}; or
$${τ}_{MT} = \frac{2 ( 1 - 2 {p}_{MT} ) ( 1 - {p}_{MT}^{{r}_{MT} + 1} )}{\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{AP} = \frac{2 ( 1 - 2 {p}_{AP} ) ( 1 - {p}_{AP}^{{r}_{AP} + 1} )}{\begin{matrix}\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} ) +\end{matrix} \\ {\frac{{CW}_{AP}}{2} [ 2 {p}_{AP} ]}^{{m}_{AP} + 1} ( 1 - 2 {p}_{AP} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP} or
$${τ}_{AP} = \frac{2 ( 1 - 2 {p}_{AP} ) ( 1 - {p}_{AP}^{{r}_{AP} + 1} )}{\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} )\end{matrix}} \qquad ( 4 )$$
Where equation (4) is valid to establish the probability that a wireless terminal transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP};
$$\begin{matrix}{TS}_{AP} = \frac{PLCP}{{R}_{PLCP}} + \frac{MAC}{{R}_{MAC}} + \frac{{L}_{AP}}{{R}_{data}} + δ + SIFS + \frac{PLCP}{{R}_{PLCP}} + \frac{ACK}{{R}_{MAC}} + δ + DIFS & ( 9 ) \\ PI = ( 1 - {τ}_{AP} ) {( 1 - {τ}_{MT} )}^{n} & ( 16 ) \\ TI = σ & ( 17 ) \\ {p}_{AP} = {τ}_{MT} & ( 18 ) \\ {p}_{MT} = 1 - ( 1 - {τ}_{AP} ) {( 1 - {τ}_{MT} )}^{( 2 k - 1 ) ( n - 1 )} & ( 19 ) \\ {S}_{Total} = {S}_{Downlink} + {S}_{Uplink} \\ {S}_{Total} = \frac{{PS}_{AP} \cdot {L}_{AP}}{\begin{matrix}PI \cdot TI + {PS}_{AP} \cdot {TS}_{AP} + {PS}_{MT} \cdot {TS}_{MT} + \\ {PC}_{AP} {TC}_{AP} + {PC}_{MT} ( AP ) {TC}_{MT} ( AP )\end{matrix}} + \frac{{PS}_{MT} \cdot {L}_{MT}}{\begin{matrix}PI \cdot TI + {PS}_{AP} \cdot {TS}_{AP} + {PS}_{MT} \cdot {TS}_{MT} + \\ {PC}_{AP} {TC}_{AP} + {PC}_{MT} ( MT ) {TC}_{MT} ( MT )\end{matrix}} & ( 20 ) \\ {PS}_{AP} = {{τ}_{AP} ( 1 - {τ}_{MT} )}^{n} & ( 21 ) \\ {PS}_{MT} = n {{τ}_{MT} ( 1 - {τ}_{MT} )}^{k ( n - 1 )} ( 1 - {τ}_{AP} ) & ( 22 ) \\ {TS}_{MT} = 4 \frac{PLCP}{{R}_{PLCP}} + \frac{MAC}{{R}_{MAC}} + \frac{{L}_{MT}}{{R}_{data}} + 4 δ + 3 SIFS + \frac{RTS + CTS + ACK}{{R}_{MAC}} + DIFS & ( 23 ) \\ {PC}_{AP} = {τ}_{AP} {τ}_{MT} & ( 25 ) \\ {PC}_{MT} ( AP ) = ( 1 - {τ}_{AP} ) [ 1 - {( 1 - {τ}_{MT} )}^{n} - n {{τ}_{tm} ( 1 - {τ}_{MT} )}^{k ( n - 1 )} ] & ( 26 ) \\ {PC}_{MT} ( MT ) = ( 1 - {τ}_{AP} ) [ {τ}_{MT} ( 1 - {( 1 - {τ}_{MT} )}^{k ( n - 1 )} ) ] & ( 27 ) \\ {TC}_{MT} ( AP ) = ( \frac{1 - {( 1 - {τ}_{MT} )}^{k ( n - 1 )}}{1 - {( 1 - {τ}_{MT} )}^{( n - 1 )}} - 1 ) \cdot ( \frac{1 - {( 1 - {τ}_{MT} )}^{k ( n - 1 )}}{1 - {( 1 - {τ}_{MT} )}^{k ( n - 1 )}} ) \cdot σ + 2 \frac{PCLP}{{R}_{PCLP}} + \frac{RTS}{{R}_{MAC}} + \frac{ACK}{{R}_{MAC}} + 2 δ + SIFS + DIFS & ( 28 ) \\ {TC}_{MT} ( MT ) = 2 \frac{PCLP}{{R}_{PCLP}} + \frac{RTS}{{R}_{MAC}} + \frac{CTS}{{R}_{MAC}} + SIFS + δ + DIFS & ( 29 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, σ, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where i (i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT}(AP) probability that a terminal experiments a collision, in presence of the hidden terminal phenomenon, from the AP's point of view;
PC_{MT}(MT) probability that a terminal experiments a collision, in presence of the hidden terminal phenomenon, from the terminals point of view;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator;
S_{Total}=S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT}(AP) time associated to the collision amongst terminal transmissions, from the AP's point of view, in presence of the hidden terminal phenomenon;
TC_{MT}(MT) time associated to the collision amongst terminal transmissions, from the terminals point of view, in presence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

12. The method in claim 10, wherein if the value of L_{MT} is larger than the RTSThreshold value of the terminals the equations to graph behavior curves are the following:
$${τ}_{MT} = \frac{2 ( 1 - 2 {p}_{MT} ) ( 1 - {p}_{MT}^{{r}_{MT} + 1} )}{\begin{matrix}\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} ) +\end{matrix} \\ {\frac{{CW}_{MT}}{2} [ 2 {p}_{MT} ]}^{{m}_{MT} + 1} ( 1 - 2 {p}_{MT} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}; or
$${τ}_{MT} = \frac{2 ( 1 - 2 {p}_{MT} ) ( 1 - {p}_{MT}^{{r}_{MT} + 1} )}{\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{AP} = \frac{2 ( 1 - 2 {p}_{AP} ) ( 1 - {p}_{AP}^{{r}_{AP} + 1} )}{\begin{matrix}\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} ) +\end{matrix} \\ {\frac{{CW}_{AP}}{2} [ 2 {p}_{AP} ]}^{{m}_{AP} + 1} ( 1 - 2 {p}_{AP} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP}; or
$${τ}_{AP} = \frac{2 ( 1 - 2 {p}_{AP} ) ( 1 - {p}_{AP}^{{r}_{AP} + 1} )}{\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} )\end{matrix}} \qquad ( 4 )$$
Where equation (4) is valid to establish the probability that a wireless terminal transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP};
$$\begin{matrix}{TS}_{AP} = \frac{PLCP}{{R}_{PLCP}} + \frac{MAC}{{R}_{MAC}} + \frac{{L}_{AP}}{{R}_{data}} + δ + SIFS + \frac{PLCP}{{R}_{PLCP}} + \frac{ACK}{{R}_{MAC}} + δ + DIFS & ( 9 ) \\ PI = ( 1 - {τ}_{AP} ) {( 1 - {τ}_{MT} )}^{n} & ( 16 ) \\ TI = σ & ( 17 ) \\ {p}_{AP} = {τ}_{MT} & ( 18 ) \\ {p}_{MT} = 1 - ( 1 - {τ}_{AP} ) {( 1 - {τ}_{MT} )}^{( 2 k - 1 ) ( n - 1 )} & ( 19 )\end{matrix}$$
$$\begin{matrix}{S}_{Total} = {S}_{Downlink} + {S}_{Uplink} \\ {S}_{Total} = \frac{{PS}_{AP} \cdot {L}_{AP}}{\begin{matrix}PI \cdot TI + {PS}_{AP} \cdot {TS}_{AP} + {PS}_{MT} \cdot {TS}_{MT} + \\ {PC}_{AP} {TC}_{AP} + {PC}_{MT} ( AP ) {TC}_{MT} ( AP )\end{matrix}} + \frac{{PS}_{MT} \cdot {L}_{MT}}{\begin{matrix}PI \cdot TI + {PS}_{AP} \cdot {TS}_{AP} + {PS}_{MT} \cdot {TS}_{MT} + \\ {PC}_{AP} {TC}_{AP} + {PC}_{MT} ( MT ) {TC}_{MT} ( MT )\end{matrix}} & ( 20 ) \\ {PS}_{AP} = {{τ}_{AP} ( 1 - {τ}_{MT} )}^{n} & ( 21 ) \\ {PS}_{MT} = n {{τ}_{MT} ( 1 - {τ}_{MT} )}^{k ( n - 1 )} ( 1 - {τ}_{AP} ) & ( 22 ) \\ {TS}_{MT} = 4 \frac{PLCP}{{R}_{PLCP}} + \frac{MAC}{{R}_{MAC}} + \frac{{L}_{MT}}{{R}_{data}} + 4 δ + 3 SIFS + \frac{RTS + CTS + ACK}{{R}_{MAC}} + DIFS & ( 23 ) \\ {PC}_{AP} = {τ}_{AP} {τ}_{MT} & ( 25 ) \\ {PC}_{MT} ( AP ) = ( 1 - {τ}_{AP} ) [ 1 - {( 1 - {τ}_{MT} )}^{n} - n {{τ}_{tm} ( 1 - {τ}_{MT} )}^{k ( n - 1 )} ] & ( 26 ) \\ {PC}_{MT} ( MT ) = ( 1 - {τ}_{AP} ) [ {τ}_{MT} ( 1 - {( 1 - {τ}_{MT} )}^{k ( n - 1 )} ) ] & ( 27 ) \\ {TC}_{MT} ( AP ) = ( \frac{1 - {( 1 - {τ}_{MT} )}^{k ( n - 1 )}}{1 - {( 1 - {τ}_{MT} )}^{( n - 1 )}} - 1 ) \cdot ( \frac{1 - {( 1 - {τ}_{MT} )}^{k ( n - 1 )}}{1 - {( 1 - {τ}_{MT} )}^{k ( n - 1 )}} ) \cdot σ + 2 \frac{PCLP}{{R}_{PCLP}} + \frac{RTS}{{R}_{MAC}} + \frac{ACK}{{R}_{MAC}} + 2 δ + SIFS + DIFS & ( 28 ) \\ {TC}_{MT} ( MT ) = 2 \frac{PCLP}{{R}_{PCLP}} + \frac{RTS}{{R}_{MAC}} + \frac{CTS}{{R}_{MAC}} + SIFS + δ + DIFS & ( 29 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, σ, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where i (i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT}(AP) probability that a terminal experiments a collision, in presence of the hidden terminal phenomenon, from the AP's point of view;
PC_{MT}(MT) probability that a terminal experiments a collision, in presence of the hidden terminal phenomenon, from the terminals point of view;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator;
S_{Total}=S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT}(AP) time associated to the collision amongst terminal transmissions, from the AP's point of view, in presence of the hidden terminal phenomenon;
TC_{MT}(MT) time associated to the collision amongst terminal transmissions, from the terminals point of view, in presence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

13. The method in claim 5, wherein if the value of L_{MT} is smaller than the RTSThreshold value of the terminals, the equations to graph behavior curves are the following:
$${τ}_{MT} = \frac{2 ( 1 - 2 {p}_{MT} ) ( 1 - {p}_{MT}^{{r}_{MT} + 1} )}{\begin{matrix}\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} ) +\end{matrix} \\ {\frac{{CW}_{MT}}{2} [ 2 {p}_{MT} ]}^{{m}_{MT} + 1} ( 1 - 2 {p}_{MT} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}; or
$${τ}_{MT} = \frac{2 ( 1 - 2 {p}_{MT} ) ( 1 - {p}_{MT}^{{r}_{MT} + 1} )}{\begin{matrix}{CW}_{MT} ( 1 - {[ 2 {p}_{MT} ]}^{{r}_{MT}} ) ( 1 - {p}_{MT} ) + \\ ( 1 - 2 {p}_{MT} ) ( 1 - {p}_{MT}^{{r}_{MT} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{AP} = \frac{2 ( 1 - 2 {p}_{AP} ) ( 1 - {p}_{AP}^{{r}_{AP} + 1} )}{\begin{matrix}\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} ) +\end{matrix} \\ {\frac{{CW}_{AP}}{2} [ 2 {p}_{AP} ]}^{{m}_{AP} + 1} ( 1 - 2 {p}_{AP} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP}; or
$${τ}_{AP} = \frac{2 ( 1 - 2 {p}_{AP} ) ( 1 - {p}_{AP}^{{r}_{AP} + 1} )}{\begin{matrix}{CW}_{AP} ( 1 - {[ 2 {p}_{AP} ]}^{{r}_{AP}} ) ( 1 - {p}_{AP} ) + \\ ( 1 - 2 {p}_{AP} ) ( 1 - {p}_{AP}^{{r}_{AP} + 1} )\end{matrix}} \qquad ( 4 )$$
Where equation (4) is valid to establish the probability that a wireless terminal transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP};
$$\begin{matrix}{TS}_{A P} = \frac{P L C P}{{R}_{P L C P}} + \frac{M A C}{{R}_{M A C}} + \frac{{L}_{A P}}{{R}_{data}} + δ + S I F S + \frac{P L C P}{{R}_{P L C P}} + \frac{ACK}{{R}_{M A C}} + δ + D I F S & ( 9 ) \\ PI = ( 1 - {τ}_{A P} ) {( 1 - {τ}_{M T} )}^{n} & ( 16 ) \\ T I = σ & ( 17 ) \\ {p}_{A P} = {τ}_{M T} & ( 18 ) \\ {p}_{M T} = 1 - ( 1 - {τ}_{A P} ) {( 1 - {τ}_{M T} )}^{( 2 k - 1 ) ( n - 1 )} & ( 19 ) \\ {S}_{Total} = {S}_{Downlink} + {S}_{Uplink} \\ {S}_{Total} = \frac{{PS}_{A P} \cdot {L}_{A P}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( A P ) {TC}_{M T} ( A P )\end{matrix}} + \frac{{PS}_{M T} \cdot {L}_{M T}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( M T ) {TC}_{M T} ( M T )\end{matrix}} & ( 20 ) \\ {PS}_{A P} = {{τ}_{A P} ( 1 - {τ}_{M T} )}^{n} & ( 21 ) \\ {PS}_{M T} = n {{τ}_{M T} ( 1 - {τ}_{M T} )}^{k ( n - 1 )} ( 1 - {τ}_{A P} ) & ( 22 ) \\ {TS}_{M T} = \frac{P L C P}{{R}_{P L C P}} + \frac{M A C}{{R}_{M A C}} + \frac{{L}_{M T}}{{R}_{data}} + δ + S I F S + \frac{P L C P}{{R}_{P L C P}} + \frac{ACK}{{R}_{M A C}} + δ + D I F S & ( 24 ) \\ {PC}_{A P} = {τ}_{A P} {τ}_{M T} & ( 25 ) \\ {PC}_{M T} ( A P ) = ( 1 - {τ}_{A P} ) [ 1 - {( 1 - {τ}_{M T} )}^{n} - n {{τ}_{tm} ( 1 - {τ}_{M T} )}^{k ( n - 1 )} ] & ( 26 ) \\ {PC}_{M T} ( M T ) = ( 1 - {τ}_{A P} ) [ {τ}_{M T} ( 1 - {( 1 - {τ}_{M T} )}^{k ( n - 1 )} ) ] & ( 27 ) \\ {TC}_{M T} ( A P ) = ( \frac{1 - {( 1 - {τ}_{M T} )}^{k ( n - 1 )}}{1 - {( 1 - {τ}_{M T} )}^{( n - 1 )}} - 1 ) \cdot ( \frac{1 - {( 1 - {τ}_{M T} )}^{k ( n - 1 )}}{1 - {( 1 - {τ}_{M T} )}^{k ( n - 1 )}} ) \cdot σ ++ 2 \frac{PCLP}{{R}_{PCLP}} + \frac{M A C}{{R}_{M A C}} + \frac{{L}_{M T}}{{R}_{data}} + \frac{ACK}{{R}_{M A C}} + 2 δ + S I F S + D I F S & ( 30 ) \\ {TC}_{M T} ( M T ) = 2 \frac{PCLP}{{R}_{PCLP}} + \frac{M A C}{{R}_{M A C}} + \frac{{L}_{M T}}{{R}_{data}} + \frac{ACK}{{R}_{M A C}} + S I F S + δ + D I F S & ( 31 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, σ, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where i (i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT}(AP) probability that a terminal experiments a collision, in presence of the hidden terminal phenomenon, from the AP's point of view;
PC_{MT}(MT) probability that a terminal experiments a collision, in presence of the hidden terminal phenomenon, from the terminals point of view;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator; S_{Total}=S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT}(AP) time associated to the collision amongst terminal transmissions, from the AP's point of view, in presence of the hidden terminal phenomenon;
TC_{MT}(MT) time associated to the collision amongst terminal transmissions, from the terminals point of view, in presence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

14. The method in claim 10, wherein if the value of L_{MT} is smaller than the RTSThreshold value of the terminals, the equations to graph behavior curves are the following:
$${τ}_{M T} = \frac{2 ( 1 - 2 {p}_{M T} ) ( 1 - {p}_{M T}^{{r}_{M T} + 1} )}{\begin{matrix}\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} ) +\end{matrix} \\ {\frac{C {W}_{M T}}{2} [ 2 {p}_{M T} ]}^{{m}_{M T} + 1} ( 1 - 2 {p}_{M T} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}, or
$${τ}_{M T} = \frac{2 ( 1 - 2 {p}_{M T} ) ( 1 - {p}_{M T}^{{r}_{M T} + 1} )}{\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{A P} = \frac{2 ( 1 - 2 {p}_{A P} ) ( 1 - {p}_{A P}^{{r}_{A P} + 1} )}{\begin{matrix}\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{APT} + 1} ) +\end{matrix} \\ {\frac{C {W}_{A P}}{2} [ 2 {p}_{A P} ]}^{{m}_{A P} + 1} ( 1 - 2 {p}_{A P} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP}; or
$${τ}_{A P} = \frac{2 ( 1 - 2 {p}_{A P} ) ( 1 - {p}_{A P}^{{r}_{A P} + 1} )}{\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{A P} + 1} )\end{matrix}} \qquad ( 4 )$$
Where equation (4) is valid to establish the probability that a wireless terminal transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP};
$$\begin{matrix}{TS}_{A P} = \frac{P L C P}{{R}_{P L C P}} + \frac{M A C}{{R}_{M A C}} + \frac{{L}_{A P}}{{R}_{data}} + δ + S I F S + \frac{P L C P}{{R}_{P L C P}} + \frac{ACK}{{R}_{M A C}} + δ + D I F S & ( 9 ) \\ PI = ( 1 - {τ}_{A P} ) {( 1 - {τ}_{M T} )}^{n} & ( 16 ) \\ T I = σ & ( 17 ) \\ {p}_{A P} = {τ}_{M T} & ( 18 ) \\ {p}_{M T} = 1 - ( 1 - {τ}_{A P} ) {( 1 - {τ}_{M T} )}^{( 2 k - 1 ) ( n - 1 )} & ( 19 ) \\ {S}_{Total} = {S}_{Downlink} + {S}_{Uplink} \\ {S}_{Total} = \frac{{PS}_{A P} \cdot {L}_{A P}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( A P ) {TC}_{M T} ( A P )\end{matrix}} + \frac{{PS}_{M T} \cdot {L}_{M T}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} ( M T ) {TC}_{M T} ( M T )\end{matrix}} & ( 20 ) \\ {PS}_{A P} = {{τ}_{A P} ( 1 - {τ}_{M T} )}^{n} & ( 21 ) \\ {PS}_{M T} = n {{τ}_{M T} ( 1 - {τ}_{M T} )}^{k ( n - 1 )} ( 1 - {τ}_{A P} ) & ( 22 ) \\ {TS}_{M T} = \frac{P L C P}{{R}_{P L C P}} + \frac{M A C}{{R}_{M A C}} + \frac{{L}_{M T}}{{R}_{data}} + δ + S I F S + \frac{P L C P}{{R}_{P L C P}} + \frac{ACK}{{R}_{M A C}} + δ + D I F S & ( 24 ) \\ {PC}_{A P} = {τ}_{A P} {τ}_{M T} & ( 25 ) \\ {PC}_{M T} ( A P ) = ( 1 - {τ}_{A P} ) [ 1 - {( 1 - {τ}_{M T} )}^{n} - n {{τ}_{tm} ( 1 - {τ}_{M T} )}^{k ( n - 1 )} ] & ( 26 ) \\ {PC}_{M T} ( M T ) = ( 1 - {τ}_{A P} ) [ {τ}_{M T} ( 1 - {( 1 - {τ}_{M T} )}^{k ( n - 1 )} ) ] & ( 27 ) \\ {TC}_{M T} ( A P ) = ( \frac{1 - {( 1 - {τ}_{M T} )}^{k ( n - 1 )}}{1 - {( 1 - {τ}_{M T} )}^{( n - 1 )}} - 1 ) \cdot ( \frac{1 - {( 1 - {τ}_{M T} )}^{k ( n - 1 )}}{1 - {( 1 - {τ}_{M T} )}^{k ( n - 1 )}} ) \cdot σ ++ 2 \frac{PCLP}{{R}_{PCLP}} + \frac{M A C}{{R}_{M A C}} + \frac{{L}_{M T}}{{R}_{data}} + \frac{ACK}{{R}_{M A C}} + 2 δ + S I F S + D I F S & ( 30 ) \\ {TC}_{M T} ( M T ) = 2 \frac{PCLP}{{R}_{PCLP}} + \frac{M A C}{{R}_{M A C}} + \frac{{L}_{M T}}{{R}_{data}} + \frac{ACK}{{R}_{M A C}} + S I F S + δ + D I F S & ( 31 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, σ, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where i (i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT}(AP) probability that a terminal experiments a collision, in presence of the hidden terminal phenomenon, from the AP's point of view;
PC_{MT}(MT) probability that a terminal experiments a collision, in presence of the hidden terminal phenomenon, from the terminals point of view;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator;
S_{Total}—S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT}(AP) time associated to the collision amongst terminal transmissions, from the AP's point of view, in presence of the hidden terminal phenomenon;
TC_{MT}(MT) time associated to the collision amongst terminal transmissions, from the terminals point of view, in presence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

15. The method in claim 5, wherein the equations to graph behavior curves are the following:
$${τ}_{M T} = \frac{2 ( 1 - 2 {p}_{M T} ) ( 1 - {p}_{M T}^{{r}_{M T} + 1} )}{\begin{matrix}\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} ) +\end{matrix} \\ {\frac{C {W}_{M T}}{2} [ 2 {p}_{M T} ]}^{{m}_{M T} + 1} ( 1 - 2 {p}_{M T} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}; or
$${τ}_{M T} = \frac{2 ( 1 - 2 {p}_{M T} ) ( 1 - {p}_{M T}^{{r}_{M T} + 1} )}{\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{A P} = \frac{2 ( 1 - 2 {p}_{A P} ) ( 1 - {p}_{A P}^{{r}_{A P} + 1} )}{\begin{matrix}\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{APT} + 1} ) +\end{matrix} \\ {\frac{C {W}_{A P}}{2} [ 2 {p}_{A P} ]}^{{m}_{A P} + 1} ( 1 - 2 {p}_{A P} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP}; or
$${τ}_{A P} = \frac{2 ( 1 - 2 {p}_{A P} ) ( 1 - {p}_{A P}^{{r}_{A P} + 1} )}{\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{A P} + 1} )\end{matrix}} \qquad ( 4 )$$
Where equation (4) is valid to establish the probability that a wireless terminal transmits (tap), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP}
$$\begin{matrix}{p}_{AP} = 1 - {( 1 - {τ}_{im} )}^{n} & ( 5 ) \\ {p}_{MT} = 1 - ( 1 - {τ}_{AP} ) {( 1 - {τ}_{MT} )}^{n - 1} \\ {S}_{Total} = {S}_{Downlink} + {S}_{Uplink} & ( 6 ) \\ {S}_{Total} = \frac{{PS}_{AP} \cdot {L}_{AP} + {PS}_{MT} \cdot {L}_{MT}}{\begin{matrix}PI \cdot TI + {PS}_{AP} \cdot {TS}_{AP} + {PS}_{MT} \cdot {TS}_{MT} + \\ {PC}_{AP} {TC}_{AP} + {PC}_{MT} {TC}_{MT}\end{matrix}} & ( 7 ) \\ {PS}_{AP} = {{τ}_{AP} ( 1 - {τ}_{MT} )}^{n} & ( 8 )\end{matrix}$$
$$\begin{matrix}{TS}_{AP} = \frac{PLCP}{{R}_{PLCP}} + \frac{MAC}{{R}_{MAC}} + \frac{{L}_{AP}}{{R}_{data}} + δ + SIFS + \frac{PLCP}{{R}_{PLCP}} + \frac{ACK}{{R}_{MAC}} + δ + DIFS & ( 9 ) \\ {PS}_{MT} = n {{τ}_{MT} ( 1 - {τ}_{MT} )}^{n - 1} ( 1 - {τ}_{AP} ) & ( 10 ) \\ {TS}_{MT} = \frac{PLCP}{{R}_{PLCP}} + \frac{MAC}{{R}_{MAC}} + \frac{{L}_{MT}}{{R}_{data}} + δ + SIFS + \frac{PCLP}{{R}_{PCLP}} + \frac{ACK}{{R}_{MAC}} + δ + DIFS & ( 11 ) \\ {PC}_{AP - MT} = {τ}_{AP} \cdot ( 1 - {( 1 - {τ}_{MT} )}^{n} ) & ( 12 ) \\ {TC}_{AP} = \frac{PLCP}{{R}_{PLCP}} + \frac{MAC}{{R}_{MAC}} + \frac{{L}_{AP}}{{R}_{data}} + δ + SIFS + \frac{PCLP}{{R}_{PCLP}} + \frac{ACK}{{R}_{MAC}} + δ + DIFS & ( 13 )\end{matrix}$$
$$\begin{matrix}{PC}_{MT} = ( 1 - {τ}_{AP} ) ⌊ 1 - {( 1 - {τ}_{MT} )}^{n} - n {{τ}_{MT} ( 1 - {τ}_{MT} )}^{n - 1} ⌋ & ( 14 ) \\ {TC}_{MT} = \frac{PLCP}{{R}_{PLCP}} + \frac{MAC}{{R}_{MAC}} + \frac{{L}_{MT}}{{R}_{data}} + δ + SIFS + \frac{PCLP}{{R}_{PCLP}} + \frac{ACK}{{R}_{MAC}} + δ + DIFS & ( 15 ) \\ PI = ( 1 - {τ}_{AP} ) {( 1 - {τ}_{MT} )}^{n} & ( 16 ) \\ TI = σ & ( 17 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, σ, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where/(i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT} probability that a transmission of a terminal experiments a collision in absence of the hidden terminal phenomenon;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator;
S_{Total}=S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT} time associated to collision amongst terminal transmissions, from the terminals point of view, in absence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

16. The method in claim 9, wherein the equations to graph behavior curves are the following:
$${τ}_{M T} = \frac{2 ( 1 - 2 {p}_{M T} ) ( 1 - {p}_{M T}^{{r}_{M T} + 1} )}{\begin{matrix}\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} ) +\end{matrix} \\ {\frac{C {W}_{M T}}{2} [ 2 {p}_{M T} ]}^{{m}_{M T} + 1} ( 1 - 2 {p}_{M T} )\end{matrix}} \qquad ( 1 )$$
Where equation (1) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{MT} is bigger than m_{MT}; or
$${τ}_{M T} = \frac{2 ( 1 - 2 {p}_{M T} ) ( 1 - {p}_{M T}^{{r}_{M T} + 1} )}{\begin{matrix}C {W}_{M T} ( 1 - {[ 2 {p}_{M T} ]}^{{r}_{M T}} ) ( 1 - {p}_{M T} ) + \\ ( 1 - 2 {p}_{M T} ) ( 1 - {p}_{M T}^{{r}_{M T} + 1} )\end{matrix}} \qquad ( 2 )$$
Where equation (2) is valid to establish the probability that a wireless terminal transmits (τ_{MT}), whose initial contention window size CW_{MT} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{MT} is equal or smaller than m_{MT};
$${τ}_{A P} = \frac{2 ( 1 - 2 {p}_{A P} ) ( 1 - {p}_{A P}^{{r}_{A P} + 1} )}{\begin{matrix}\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{APT} + 1} ) +\end{matrix} \\ {\frac{C {W}_{A P}}{2} [ 2 {p}_{A P} ]}^{{m}_{A P} + 1} ( 1 - 2 {p}_{A P} )\end{matrix}} \qquad ( 3 )$$
Where equation (3) is valid to establish the probability that the AP transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is exceeded, this translates into that the value of r_{AP} is bigger than m_{AP}; or
$${τ}_{A P} = \frac{2 ( 1 - 2 {p}_{A P} ) ( 1 - {p}_{A P}^{{r}_{A P} + 1} )}{\begin{matrix}C {W}_{A P} ( 1 - {[ 2 {p}_{A P} ]}^{{r}_{A P}} ) ( 1 - {p}_{A P} ) + \\ ( 1 - 2 {p}_{A P} ) ( 1 - {p}_{A P}^{{r}_{A P} + 1} )\end{matrix}} . \qquad ( 4 )$$
Where equation (4) is valid to establish the probability that a wireless terminal transmits (τ_{AP}), whose initial contention window size CW_{AP} has been adjusted to a value such that in the case of retransmitting a data packet 4 times (or 7 times for a RTS packet) because the adequate answer has not been obtained (an ACK or CTS packet respectively), the maximum contention window value CWmax is not exceeded, this translates into that the value of r_{AP} is equal or smaller than m_{AP};
$$\begin{matrix} {p}_{A P} = 1 - {( 1 - {τ}_{tm} )}^{n} & ( 5 ) \\ {p}_{M T} = 1 - ( 1 - {τ}_{A P} ) {( 1 - {τ}_{M T} )}^{n - 1} & ( 6 ) \\ {S}_{Total} = {S}_{Downlink} + {S}_{Uplink} \\ {S}_{Total} = \frac{{PS}_{A P} \cdot {L}_{A P} + {PS}_{M T} \cdot {L}_{M T}}{\begin{matrix}PI \cdot T I + {PS}_{A P} \cdot {TS}_{A P} + {PS}_{M T} \cdot {TS}_{M T} + \\ {PC}_{A P} {TC}_{A P} + {PC}_{M T} {TC}_{M T}\end{matrix}} & ( 7 ) \\ {PS}_{A P} = {{τ}_{A P} ( 1 - {τ}_{M T} )}^{n} & ( 8 ) \\ {TS}_{A P} = \frac{P L C P}{{R}_{P L C P}} + \frac{M A C}{{R}_{M A C}} + \frac{{L}_{A P}}{{R}_{data}} + δ + S I F S + \frac{P L C P}{{R}_{P L C P}} + \frac{ACK}{{R}_{M A C}} + δ + D I F S & ( 9 ) \\ {PS}_{M T} = n {{τ}_{M T} ( 1 - {τ}_{M T} )}^{n - 1} ( 1 - {τ}_{A P} ) & ( 10 ) \\ {TS}_{M T} = \frac{P L C P}{{R}_{P L C P}} + \frac{M A C}{{R}_{M A C}} + \frac{{L}_{M T}}{{R}_{data}} + δ + S I F S + \frac{PCLP}{{R}_{PCLP}} + \frac{ACK}{{R}_{M A C}} + δ + D I F S & ( 11 ) \\ {PC}_{A P - M T} = {τ}_{A P} \cdot ( 1 - {( 1 - {τ}_{M T} )}^{n} ) & ( 12 ) \\ {TC}_{A P} = \frac{P L C P}{{R}_{P L C P}} + \frac{M A C}{{R}_{M A C}} + \frac{{L}_{A P}}{{R}_{data}} + δ + S I F S + \frac{PCLP}{{R}_{PCLP}} + \frac{ACK}{{R}_{M A C}} + δ + D I F S & ( 13 ) \\ {PC}_{M T} = ( 1 - {τ}_{A P} ) ⌊ 1 - {( 1 - {τ}_{M T} )}^{n} - n {{τ}_{M T} ( 1 - {τ}_{M T} )}^{n - 1} ⌋ & ( 14 ) \\ {TC}_{M T} = \frac{P L C P}{{R}_{P L C P}} + \frac{M A C}{{R}_{M A C}} + \frac{{L}_{M T}}{{R}_{data}} + δ + S I F S + \frac{PCLP}{{R}_{PCLP}} + \frac{ACK}{{R}_{M A C}} + δ + D I F S & ( 15 ) \\ PI = ( 1 - {τ}_{A P} ) {( 1 - {τ}_{M T} )}^{n} & ( 16 ) \\ T I = σ & ( 17 )\end{matrix}$$
Wherein,
ACK is the packet size of the acknowledgement of a data transmission, sent by the destination node to the source node of the data packet, in bits;
AP Access Point;
CSMA/CA Carrier Sense Multiple Access with Collision Avoidance;
CTS Clear To Send, is the packet size that authorizes a packet transmission, in bits;
CW is the initial contention window parameter of the device (MT or AP);
CW_{AP} is the initial value of the configurable contention window value of the AP;
CW_{MT} is the initial value of the configurable contention window for each one of the terminals;
DCF Distributed Coordination Function, defines the random access or, basic access, mode of functioning with the IEEE 802.11 standard, based on CSMA/CA protocol;
DIFS DCF Inter Frame Space is the time that every device in a wireless network must remain idle after an ACK frame;
k is the number of collision slot intervals, a, that are counted for the transmission of the RTS packet;
L_{AP} average expected length of an IP data packet in bits, which will be transmitted by the MAC layer of the AP;
L_{MT} average expected length of an IP data packet in bits, which will be transmitted by the MAC layer of the terminals;
MAC refers to the number of bits that constitute the field associated to the necessary control information that needs to be transmitted;
m_{AP} is the maximum number of times that the AP may retransmit when functioning in basic access mode, without exceeding the maximum window size 2ⁱ·CW_{AP}<CWmax, where i (i≦4) is the number of retransmissions in basic access mode;
m_{MT} is the maximum number of times that the terminal may retransmit when functioning in basic access mode, without exceeding the maximum window size 2ⁱ·CW_{MT}<CWmax, where i (i≦4) is the number of retransmissions in basic access mode (when operating with the RTS/CTS mechanism i≦7);
MaxPDUsize is the maximum data packet size that may be encapsulated in a MAC frame;
MT refers to the mobile terminal;
n is the number of terminals present in the wireless network;
p_{AP} is the collision probability that an AP transmission experiments;
p_{MT} is the collision probability that a terminal transmission experiments;
PC_{AP} probability that a transmission of the AP experiments a collision;
PC_{MT} probability that a transmission of a terminal experiments a collision in absence of the hidden terminal phenomenon;
PI probability that the channel remains idle during a collision interval;
PLCP Physical Layer Convergence Protocol, is the header of the PHY layer that all wireless transmissions have, in bits;
PS_{AP} probability that the AP experiments a successful transmission;
PS_{MT} probability that a terminal experiments a successful transmission;
R_{data} is the data transmission rate that the wireless network devices employ;
R_{MAC} is the transmission rate that the wireless network devices use to transmit the MAC layer header;
R_{PCLP} is the transmission rate that the wireless network devices use to transmit the PHY layer header;
RTS Request To Send, is the request to send packet size in bits;
RTSThreshold activation threshold for the RTS/CTS mechanism;
r_{AP} is the maximum number of times that the AP may retransmit when operating in the basic access mode;
r_{MT} is the maximum number of times that a terminal may retransmit, when functioning in basic access mode this corresponds to 4 times and when employing the RTS/CTS mechanism it is 7 times;
SE Signal Extension is an additional time defined by IEEE 802.11g;
SIFS Short Inter Frame Space, is the time taken previous to an ACK and CTS frame;
S_{Uplink} is the maximum throughput that the network terminals may obtain when using the parameters specified by the standard and those configured by the network administrator;
S_{Downlink} is the maximum throughput that is obtained by downlink traffic from the AP, when using the parameters specified by the standard and those configured by the network administrator;
S_{Total}=S_{Uplink}+S_{Downlink} is the maximum global throughput that can be obtained from the network when using the parameters specified by the standard and those configured by the network administrator;
TC_{AP} time associated to the collision between the AP transmission with the terminal whom it wants to transmit to, from the AP's point of view;
TC_{MT} time associated to collision amongst terminal transmissions, from the terminals point of view, in absence of the hidden terminal phenomenon;
TI idle time of the wireless channel;
TS_{AP} time associated to a successful AP transmission;
TS_{MT} time associated to a successful terminal transmission;
δ time associated to the commutation from receiving to transmitting in a wireless device;
σ duration of a time slot during a collision interval;
τ_{AP} probability that the AP transmits; and
τ_{MT} probability that a terminal transmits.

17. The method in claims 12, wherein compromise a graph analysis of the throughput behavior curves of total, uplink and downlink traffic, dependent of the initial contention window size of the AP (CW_{AP}) in such a way that they are higher to a transmission rate threshold per terminal, establishing the maximum number of terminals supported by the wireless network that are over this threshold.

18. The method in claims 12, wherein compromise a graph analysis of the throughput behavior curves of total, uplink and downlink traffic, dependent of the initial contention window size of the AP (CW_{AP}) in such a way that they are higher to a transmission rate threshold per terminal, establishing the maximum number of terminals supported by the wireless network that are over this threshold.

19. The method in claims 14, wherein compromise a graph analysis of the throughput behavior curves of total, uplink and downlink traffic, dependent of the initial contention window size of the AP (CW_{AP}) in such a way that they are higher to a transmission rate threshold per terminal, establishing the maximum number of terminals supported by the wireless network that are over this threshold.

20. The method in claims 15, wherein compromise a graph analysis of the throughput behavior curves of total, uplink and downlink traffic, dependent of the initial contention window size of the AP (CW_{AP}) in such a way that they are higher to a transmission rate threshold per terminal, establishing the maximum number of terminals supported by the wireless network that are over this threshold.

21. The method in claims 16, wherein compromise a graph analysis of the throughput behavior curves of total, uplink and downlink traffic, dependent of the initial contention window size of the AP (CW_{AP}) in such a way that they are higher to a transmission rate threshold per terminal, establishing the maximum number of terminals supported by the wireless network that are over this threshold.

22. The method in claims 12, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

23. The method in claims 13, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

24. The method in claims 14, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

25. The method in claims 15, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

26. The method in claims 16, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

27. The method of claim 2, wherein the determined configuration parameters are the values of CW_{AP} that comply with the maximum number of determined terminals that the network supports, according to the behavior curves of the wireless network.

28. The method of claim 7, wherein the determined configuration parameters are the values of CW_{AP} that comply with the maximum number of determined terminals that the network supports, according to the behavior curves of the wireless network.

29. The method of claim 15, wherein the determined configuration parameters are the values of CW_{AP} that comply with the maximum number of determined terminals that the network supports, according to the behavior curves of the wireless network.

30. The method of claim 17, wherein the determined configuration parameters are the values of CW_{AP} that comply with the maximum number of determined terminals that the network supports, according to the behavior curves of the wireless network.

31. The method of claim 18, wherein the determined configuration parameters are the values of CW_{AP} that comply with the maximum number of determined terminals that the network supports, according to the behavior curves of the wireless network.

32. The method of claim 19, wherein the determined configuration parameters are the values of CW_{AP} that comply with the maximum number of determined terminals that the network supports, according to the behavior curves of the wireless network.

33. The method of claim 20, wherein the determined configuration parameters are the values of CW_{AP} that comply with the maximum number of determined terminals that the network supports, according to the behavior curves of the wireless network.

34. The method of claim 21, wherein the determined configuration parameters are the values of CW_{AP} that comply with the maximum number of determined terminals that the network supports, according to the behavior curves of the wireless network.

35. The method of claim 23, wherein the determined configuration parameters are the values of CW_{AP} that comply with the maximum number of determined terminals that the network supports, according to the behavior curves of the wireless network.

36. The method of claim 24, wherein the determined configuration parameters are the values of CW_{AP} that comply with the maximum number of determined terminals that the network supports, according to the behavior curves of the wireless network.

37. The method of claim 25, wherein the determined configuration parameters are the values of CW_{AP} that comply with the maximum number of determined terminals that the network supports, according to the behavior curves of the wireless network.

38. The method of claim 26, wherein the determined configuration parameters are the values of CW_{AP} that comply with the maximum number of determined terminals that the network supports, according to the behavior curves of the wireless network.

39. The method of claims 11, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

40. The method of claims 12, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

41. The method of claims 13, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

42. The method of claims 15, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

43. The method of claims 16, wherein compromise a graph analysis of the throughput behavior curves of total, uplink and downlink traffic, dependent of the initial contention window size of the AP (CW_{AP}), in such a way that an equal proportion exists between the relationship L_{AP}/L_{MT} and the uplink and downlink traffic, establishing the maximum number of terminals supported by the wireless network that present a value equal or higher to this relationship.

44. The method of claim 27, wherein the determined configuration parameters are the values of CW_{AP} that comply with the maximum number of determined terminals that the network supports, according to the behavior curves of the wireless network.

45. The method of claim 28, wherein the determined configuration parameters are the values of CW_{AP} that comply with the maximum number of determined terminals that the network supports, according to the behavior curves of the wireless network.

46. The method of claim 29, wherein the determined configuration parameters are the values of CW_{AP} that comply with the maximum number of determined terminals that the network supports, according to the behavior curves of the wireless network.

47. The method of claim 30, wherein the determined configuration parameters are the values of CW_{AP} that comply with the maximum number of determined terminals that the network supports, according to the behavior curves of the wireless network.

48. The method of claim 31, wherein the determined configuration parameters are the values of CW_{AP} that comply with the maximum number of determined terminals that the network supports, according to the behavior curves of the wireless network.

49. The method of claim 32, wherein the determined configuration parameters are the values of CW_{AP} that comply with the maximum number of determined terminals that the network supports, according to the behavior curves of the wireless network.

50. The method of claim 33, wherein the determined configuration parameters are the values of CW_{AP} that comply with the maximum number of determined terminals that the network supports, according to the behavior curves of the wireless network.

51. The method of claim 34, wherein the determined configuration parameters are the values of CW_{AP} that comply with the maximum number of determined terminals that the network supports, according to the behavior curves of the wireless network.

52. The method of claim 35, wherein the determined configuration parameters are the values of CW_{AP} that comply with the maximum number of determined terminals that the network supports, according to the behavior curves of the wireless network.

53. The method of claim 36, wherein the determined configuration parameters are the values of CW_{AP} that comply with the maximum number of determined terminals that the network supports, according to the behavior curves of the wireless network.

54. The method of claim 37, wherein the determined configuration parameters are the values of CW_{AP} that comply with the maximum number of determined terminals that the network supports, according to the behavior curves of the wireless network.

55. The method of claim 38, wherein the determined configuration parameters are the values of CW_{AP} that comply with the maximum number of determined terminals that the network supports, according to the behavior curves of the wireless network.

56. The method of claim 39, wherein the determined configuration parameters are the values of CW_{AP} that comply with the maximum number of determined terminals that the network supports, according to the behavior curves of the wireless network.

57. The method of claim 40, wherein the determined configuration parameters are the values of CW_{AP} that comply with the maximum number of determined terminals that the network supports, according to the behavior curves of the wireless network.

58. The method of claim 41, wherein the determined configuration parameters are the values of CW_{AP} that comply with the maximum number of determined terminals that the network supports, according to the behavior curves of the wireless network.

59. The method of claim 42, wherein the determined configuration parameters are the values of CW_{AP} that comply with the maximum number of determined terminals that the network supports, according to the behavior curves of the wireless network.

60. The method of claim 43, wherein the determined configuration parameters are the values of CW_{AP} that comply with the maximum number of determined terminals that the network supports, according to the behavior curves of the wireless network.
